(19) United States
(12) Patent Application Publication
(10) Pub. No.: US 2013/0217254 A1
(43) Pub. Date: Aug. 22, 2013

(54) TELEVISION RECEIVER AND ELECTRONIC DEVICE

(71) Applicant: KABUSHIKI KAISHA TOSHIBA, (US)

(72) Inventors: Hideo SHIRASAKA, Tokyo (JP); Shigeki NISHIYAMA, Tokyo (JP)

(73) Assignee: KABUSHIKI KAISHA TOSHIBA, Tokyo (JP)

(21) Appl. No.: 13/710,224

(22) Filed: Dec. 10, 2012

(30) Foreign Application Priority Data
Feb. 16, 2012 (JP) 2012-031919

(51) Int. Cl. H01R 13/639

(52) U.S. Cl. CPC H01R 13/639
USPC 439/345

(57) ABSTRACT

According to one embodiment, television receiver includes: display; first housing; second housing; first member; second member; disk; shaft; arm; lid member; protrusion; and shock absorber. The first housing includes container and first connector facing the container. The second housing is removably housed in the container. The second housing includes second connector electrically connected to first connector. The lid member covers container. The protrusion is provided to the lid member, positioned opposite the first connector with respect to the second connector, protrudes into the container, and prevents the first connector and the second connector from being separated from each other and electrically disconnected. The shock absorber is provided to at least one of the first housing, the second housing, and the lid member, and prevents a force applied from the lid member from acting on the second member via the protrusion.

### CROSS-REFERENCE TO RELATED APPLICATIONS

This application is based upon and claims the benefit of priority from Japanese Patent Application No. 2012-031919, filed Feb. 16, 2012; the entire contents of which are incorporated herein by reference.

### FIELD

Embodiments described herein relate generally to a television receiver and an electronic device.

### BACKGROUND

Conventionally known is an electronic device comprising a housing provided with a container for housing a module, and in which a connector of the housing is electrically connected to a connector of the module.

In this type of electronic device, as an example, it has been desired to reduce an impact of an external force applied to the module.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a television receiver according to a first embodiment;

FIG. 2 is an exemplary side view of the television receiver in the first embodiment;

FIG. 3 is an exemplary perspective view of a module and a holder housed in the television receiver in the first embodiment;

FIG. 4 is an exemplary perspective view of the module and the holder illustrated in FIG. 3, as viewed from another angle, in the first embodiment;

FIG. 5 is an exemplary perspective view of the module housed in the television receiver in the first embodiment;

FIG. 6 is an exemplary exploded perspective view of the module housed in the television receiver in the first embodiment;

FIG. 7 is an exemplary perspective view of the holder of the module housed in the television receiver in the first embodiment;

FIG. 8 is an exemplary plan view (rear view) of a container provided in the television receiver in the first embodiment;

FIG. 9 is an exemplary plan view (rear view) of the module housed in the container illustrated in FIG. 8, prior to when connectors are electrically connected, in the first embodiment;

FIG. 10 is an exemplary plan view (rear view) of the module housed in the container illustrated in FIG. 8, with the connectors being electrically connected, in the first embodiment;

FIG. 11 is an exemplary plan view (rear view) of the container housing the module illustrated in FIG. 10 and covered by a lid member, in the first embodiment;

FIG. 12 is an exemplary cross-sectional view, in a plan view (rear view), of the connector provided to the housing and the connector provided to the module of the television receiver, prior to when the connectors are electrically connected to each other, in the first embodiment;

FIG. 13 is an exemplary cross-sectional view, in a plan view (rear view), of the connectors illustrated in FIG. 12 that are electrically connected to each other, in the first embodiment;

FIG. 14 is an exemplary schematic diagram of the module at a first position, in a cross section equivalent to the cross section taken along the line XV-XV in FIG. 13, in the first embodiment;

FIG. 15 is an exemplary cross-sectional view taken along the line XV-XV in FIG. 13, in the first embodiment;

FIG. 16 is an exemplary perspective view of the lid member illustrated in FIG. 11, in the first embodiment;

FIG. 17 is an exemplary schematic diagram illustrating a cross section across XVII-XVII in FIG. 11;

FIG. 18 is an exemplary schematic diagram illustrating a cross section (cross section taken along the line XVIII-XVIII in FIG. 17), in a plan view (rear view), of an internal structure of the television receiver in the first embodiment;

FIG. 19 is an exemplary perspective view of an electronic device in a second embodiment;

FIG. 20 is an exemplary plan view (bottom view, rear view) of a first housing of the electronic device in the second embodiment;

FIG. 21 is an exemplary plan view (bottom view, rearview) of an container provided to the first housing of the electronic device in the second embodiment;

FIG. 22 is an exemplary schematic diagram illustrating a cross section taken along the line XXII-XXII in FIG. 20, in the second embodiment;

FIG. 23 is an exemplary schematic diagram illustrating a cross section (cross section at a position equivalent to that in FIG. 18), in a plan view, of a portion of an internal structure of an electronic device according to a first modification;

FIG. 24 is an exemplary schematic diagram illustrating a cross section (cross section at a position equivalent to that of FIG. 18), in a plan view, of a portion of an internal structure of an electronic device according to a second modification;

FIG. 25 is an exemplary schematic diagram illustrating a cross section, in a side view, of a portion of an internal structure of an electronic device according to a third modification;

FIG. 26 is an exemplary schematic diagram illustrating a cross section, in a side view, of an example of a portion of an internal structure of an electronic device according to a fourth modification;

FIG. 27 is an exemplary schematic diagram illustrating a cross section (cross section at a position equivalent to that of FIG. 18), in a plan view, of a portion of the internal structure of the electronic device in the fourth modification;

FIG. 28 is an exemplary schematic diagram illustrating a cross section, in a side view, of a portion of an internal structure of an electronic device according to a fifth modification;

FIG. 29 is an exemplary schematic diagram illustrating a cross section, in a side view, of a portion of an internal structure of an electronic device according to a sixth modification;

FIG. 30 is an exemplary perspective view illustrating a holder for holding a module housed in an electronic device according to a seventh modification;

FIG. 31 is an exemplary schematic diagram illustrating a cross section, in a side view, of a portion of the internal structure of the electronic device in the seventh modification;

FIG. 32 is an exemplary schematic diagram illustrating a cross section (cross section at a position equivalent to that of FIG. 18), in a plan view, of a portion of an internal structure of an electronic device according to an eighth modification;

FIG. 33 is an exemplary schematic diagram illustrating a cross section (cross section at a position equivalent to that of FIG. 18), in a plan view, of a portion of an internal structure of an electronic device according to a ninth modification;

FIG. 34 is an exemplary schematic diagram illustrating a cross section (cross section at a position equivalent to that of FIG. 18), in a plan view, of a portion of an internal structure of an electronic device according to a tenth modification;

FIG. 35 is an exemplary schematic diagram illustrating a cross section (cross section at a position equivalent to that of FIG. 18), in a plan view, of a portion of an internal structure of an electronic device according to an eleventh modification;

FIG. 36 is an exemplary perspective view of a module housed in an electronic device according to a twelfth modification; and

FIG. 37 is an exemplary plan view (partial cross-sectional view) schematically illustrating a module and a suppressor housed in an electronic device according to a thirteenth modification.

### DETAILED DESCRIPTION

In general, according to one embodiment, a television receiver comprises: a display; a first housing; a second housing; a first member; a second member; a disk; a shaft; an art; a lid member; a protrusion; and a shock absorber. The display comprises a screen. The first housing is configured to at least partially house the display device so that the screen is exposed. The first housing comprises a container and a first connector facing the container. The second housing is configured to be removably housed in the container. The second housing comprises a second connector electrically connected to the first connector. The first member comprises an opening and a first portion of the second housing. The second member is configured to cover the opening. The second member comprises a second portion of the second housing. The disk is configured to be rotatably supported by the first member. The shaft is configured to be offset from the disk, and to extend between the first member and the second member. The arm is configured to support a head facing the disk, and to be rotatably supported by the shaft. The lid member is configured to cover the container and to be removably provided to the first housing. The protrusion is configured to be provided to the lid member, to be opposite the first connector with respect to the second connector, to protrude into the container, and to prevent the first connector and the second connector from being separated from each other and electrically disconnected. The shock absorber is configured to be provided to at least one of the first housing, the second housing, and the lid member, and to prevent a force applied from the lid member from acting on the second member via the protrusion.

In exemplary embodiments and modifications to be described below, some common elements are included. Therefore, in explanations below, the same reference numerals are assigned to the same elements, and redundant explanations of the same elements are partially omitted. Parts included in one of the embodiments and the modifications may be replaced with corresponding parts included in the other embodiments and modifications. Unless otherwise specified, a part included in one of the embodiments and the modifications has the same structure and placed at the same position as that in the other embodiments and modifications. In each of the drawings, directions (an X direction, a Y direction, and a Z direction) are illustrated for convenience. The X direction corresponds to the longitudinal direction of a wall 3a of a housing 3A or a first housing 3B in a front view (hereinafter, referred to, seen in a plan view, in the embodiments). The Y direction corresponds to the short side direction of the wall 3a of the housing 3A or the first housing 3B in the front view (plan view). The Z direction corresponds to the thickness direction of the housing 3A or the first housing 3B. The X direction, the Y direction, and the Z direction perpendicularly cross each other.

In the embodiments to be described below, explained as an example is an electronic device configured as a television receiver or a personal computer; however, the electronic device according to the embodiments is not limited thereto. For example, the electronic device according to the embodiment may be various electronic devices, such as a smartphone, a smart book, a cellular phone, a personal digital assistant (PDA), a video display device, a video phone, a video display controlling device, and information storage device, comprising a container where a module is enclosed.

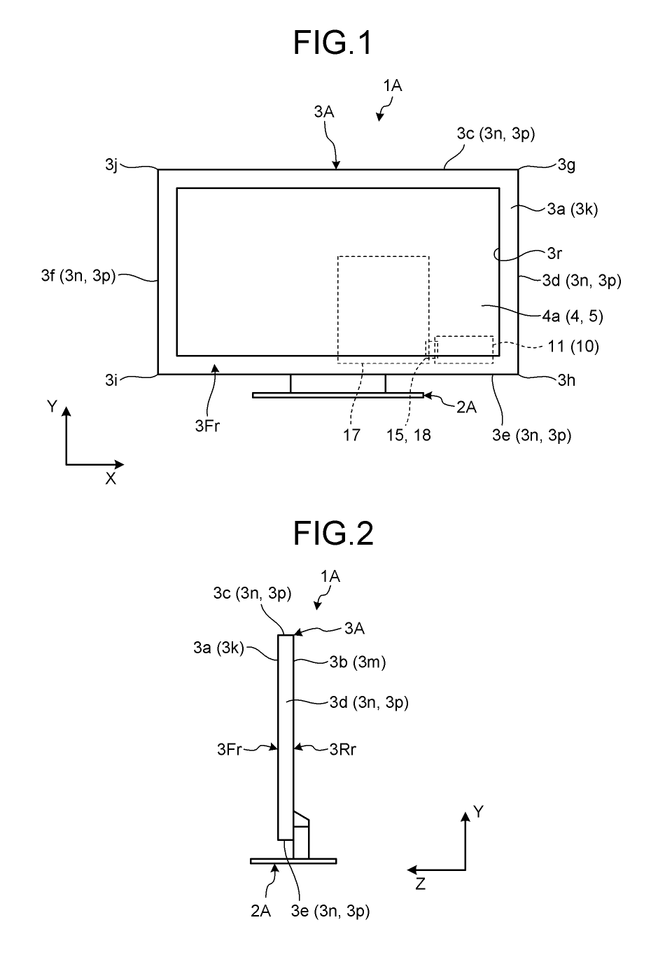

A television receiver 1A that is an example of an electronic device according to a first embodiment comprises a support 2A (a supporting portion, a station, a stand) and a housing 3A (a first housing), as illustrated in FIGS. 1 and 2. Specifically, the support 2A is placed on a setting area such as a desk, a shelf, and a table (setting surface not illustrated), and supports the housing 3A at an upright orientation. The support 2A may be fixed to the housing 3A, or may support the housing 3A movably (rotatably, slidably). The support 2A may be movable (rotatable) with respect to the housing 3A by being tilted, swiveled, or pivoted, for example.

In the first embodiment, as may be understood from FIG. 1, the housing 3A has an external appearance of a rectangular shape (in the first embodiment, an oblong shape, as an example) in the front view and the rear view, as an example. The housing 3A also has a cuboid shape that is thin and flat in the front-back direction (the thickness direction of the housing 3A, the Z direction), as illustrated in FIG. 2. The housing 3A has a surface 3a (a frontal surface, a front surface, a surface portion) and a surface 3b (a back surface, a rear surface, a surface portion) located on the opposite side of the housing 3A. The surface 3a and the surface 3b are laid approximately in parallel (in the first embodiment, in parallel, as an example). The housing 3A also has four ends 3c to 3f (sides, edge portions) and four corners 3g to 3j (pointed portions, curved portions, ends) in the front view, as illustrated in FIG. 1. The ends 3c and 3e are examples of longer sides. Ends 3d and 3f are examples of shorter sides. The housing 3A functions as a container where components (not illustrated) are enclosed, as an example, and may also function as a support for supporting an object with some weight (e.g., a display device 4 or a component).

The housing 3A comprises a wall 3k (a part, a plate, a frame, a front wall, a frontal wall, a top wall) including the surface 3a, and a wall 3m (a part, a plate, a rear wall, a back wall, a bottom wall) including the surface 3b. The walls 3k and 3m both have a rectangular shape (in the first embodiment, an oblong shape, as an example). The wall 3k also has a frame-like shape, and the wall 3m has a plate-like shape. The housing 3A has four walls 3n (parts, plates, side walls, end walls, standing walls, stretched portions) each of which includes a surface 3p (a surface, a circumferential surface) stretching between the wall 3k and the wall 3m. A rectangular opening 3r is provided to the wall 3k.

The housing 3A is made from a combination of a plurality of parts (divided portions, members). The housing 3A comprises a first member 3Fr (a first part, a front side member, a cover, a bezel, a frame) including at least the wall 3k, and a second member 3Rr (a second part, a rear side member, a base, a bottom, a plate, a cover) at least including the wall 3m, as an example. In the first embodiment, the walls 3n are configured as a portion of the second member 3Rr, as an example. The housing 3A may also comprise a third member (a third part, an intermediate member, an inner, a middle frame, a middle plate, not illustrated), in addition to the first member 3Fr and the second member 3Rr. Some portions of the walls 3k, 3m, and 3n may be included as a portion of the third member. The first member 3Fr, the second member 3Rr, the third member, and the like may be made of a metallic material or a synthetic resin material, for example.

In the first embodiment, as an example, the display device 4 (a display module, a display, a panel, a display component) is housed in the housing 3A. Specifically, a display screen 4a of the display device 4 located on the side of the surface 3a is exposed to the front side (outside) of the housing 3A through the opening 3r. A user can view the display screen 4a from the front side through the opening 3r. The display device 4 has an external appearance of a rectangular shape (in the first embodiment, an oblong shape, as an example) in the front view. The display device 4 also has a cuboid shape that is thin and flat in the front-back direction. The display device 4 is a liquid crystal display (LCD), an organic electro-luminescent display (OELD), or a plasma display panel (PDP), for example.

In the first embodiment, as an example, a transparent, relatively thin, and rectangular input operation panel 5 (as an example, a touch panel, a touch sensor, an operation surface, an input operation module, an input receiving module) is provided to the front side (frontal side, the side of the wall 3k) of the display device 4. The input operation panel 5 covers the display screen 4a. An operator (e.g., a user) can make inputs by making operations such as touching, pressing, rubbing the input operation panel 5, or moving a hand, a finger, or a stylus near the input operation panel 5. Light output from the display screen 4a of the display device 4 passes through the input operation panel 5 and travels to the front side (outside) of the housing 3A through the opening 3r on the wall 3k. The input operation panel 5 is an example of an input module. In the first embodiment, as an example, the display device 4 and the input operation panel 5 are fixed to (supported by) one of the first member 3Fr, the second member 3Rr, and the third member using fixtures (fixing components, clamps; e.g., screws, clamps, or components, not illustrated), an adhesive (e.g., an adhesive agent, or a double-sided adhesive tape, not illustrated), and the like.

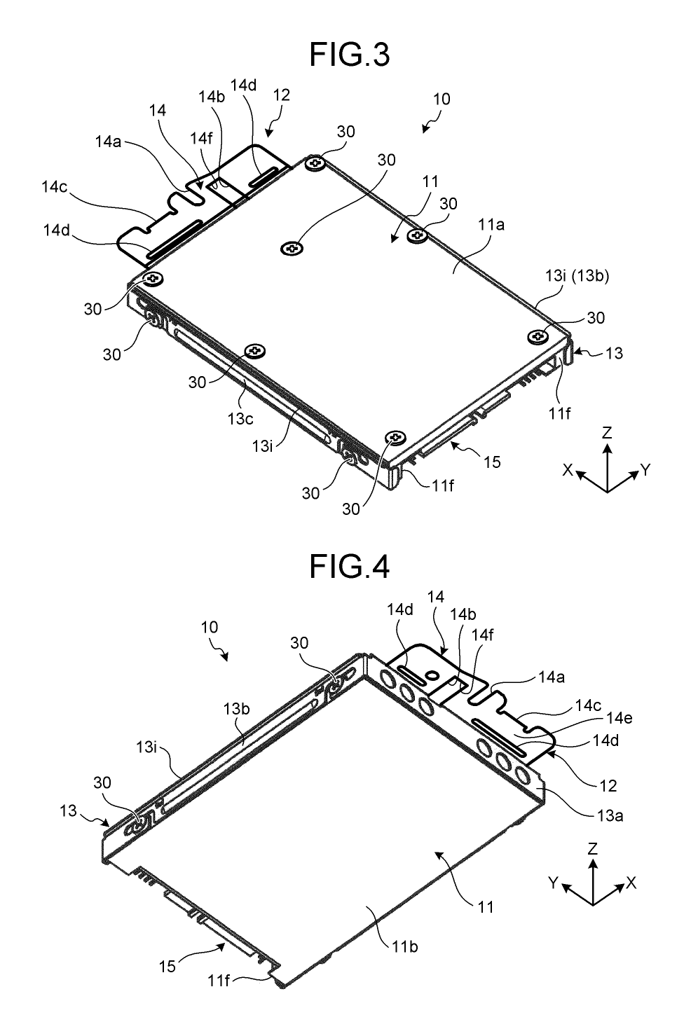

In the first embodiment, as an example, as illustrated in FIGS. 3 and 4, a sub-assembly 10 comprises a module 11 (an electric component, an electronic component, attachment components, components) and a holder 12 (a support, a attaching portion, an intermediating portion, n attachment, an adjuster, a supporting member, an attaching member, an auxiliary member, parts, third member). The module 11 is a hard disk drive (HDD) in the first embodiment, as an example. The module 11 can be mounted onto the housing 3A in a removable manner. The module 11 may also be an optical disk drive (ODD) or a solid state drive (SSD), for example. The sub-assembly 10 is also an example of a module.

In the first embodiment, as an example, as illustrated in FIGS. 3 to 6, the module 11 is configured as a flat cuboid. The module 11 has an external appearance of a rectangular shape (in the first embodiment, an oblong shape, as an example) in a plan view as viewed from a direction of a first surface 11a or a second surface 11b located on the opposite side of the first surface 11a (viewed in the thickness direction, viewed in the Z direction).

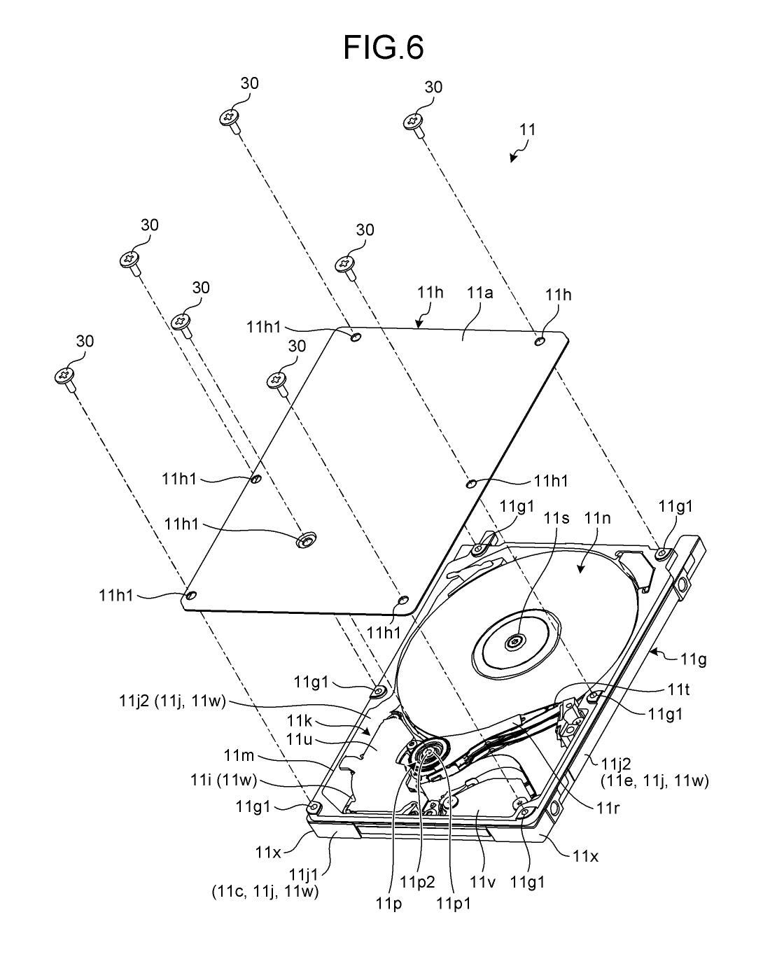

In the first embodiment, as an example, as illustrated in FIG. 6, the module 11 comprises a first member 11g (a case, an container, a base portion) and a second member 11h (a wall, a lid, a cover, a third wall). The first member 11g and the second member 11h are examples of a housing 11w of the module 11 (a second housing). The housing 11w may be made of a metallic material or a synthetic resin material, for example. The housing of the module 11 (a second housing) may be made from two or more members.

The first member 11g has a rectangular shape (in the first embodiment, an oblong shape, as an example), and is configured as a case having a relatively thin cuboid shape that comprises a plate-like wall 11i (a bottom wall, a lower wall, a lateral wall) and a band-like and plate-like wall 11j (a side wall, a standing wall) surrounding the wall 11i and extending at an approximately constant height. In other words, the first member 11g comprises a container 11k surrounded by the walls 11i and 11j, and an opening 11m that opens the container 11k. The opening 11m is covered and closed by the second member 11h (a wall) having a rectangular (in the first embodiment, an oblong shape, as an example), plate-like shape. The first member 11g comprises a plurality of coupling portions 11g1 (in the first embodiment, female screw hole, as an example). The second member 11h comprises coupling portions 11h1 provided at positions corresponding to the positions of the coupling portions 11g1. Couplers 30 (in the first embodiment, screws, as an example) passed through the respective coupling portions 11h1 are coupled to the respective coupling portions 11h1, and, in this manner, the first member 11g and the second member 11h are coupled to each other. The first member and the second member may have a different shape.

A disk 11n, a shaft 11p, an arm 11r, an actuator 11u, a controlling circuit 11v, and the like as components are housed in the first member 11g. The disk 11n is a magnetic disk, and is rotatably supported by a shaft 11s located at the center (in the middle) of the disk 11n, about the shaft 11s. A plurality of disks 11n may be stacked in the module 11. The arm 11r is rotatably (swingably) supported by the shaft 11p placed at a position offset from the disk 11n. A head 11t is provided at the tip of the arm 11r, in a manner facing the disk 11n. The head 11t magnetically reads or writes data from or to the disk 11n. In a configuration where a plurality of disks 11n are provided to the module 11, the arm 11r and the head 11t are provided correspondingly to each of the disks 11n.

The shaft 11p extends between the wall 11i of the first member 11g and the second member 11h, and ends of the shaft 11p are respectively supported by the wall 11i and the second member 11h. A coupling portion 11p2 (in the first embodiment, a female screw hole, as an example) is provided on an end 11p1 of the shaft 11p, being the end located on the side of the second member 11h. A coupling portion 11h1 (in the first embodiment, an opening, as an example) is provided to the second member 11h, at a position corresponding to the position of the coupling portion 11p2. The coupler 30 (in the first embodiment, screws, as an example) passed through the coupling portion 11h1 is coupled to the coupling portion 11p2. In this manner, the shaft 11p and the second member 11h are coupled to each other.

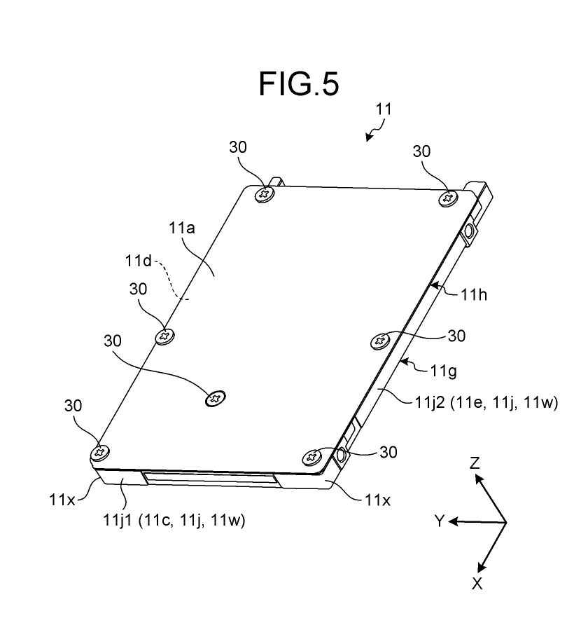

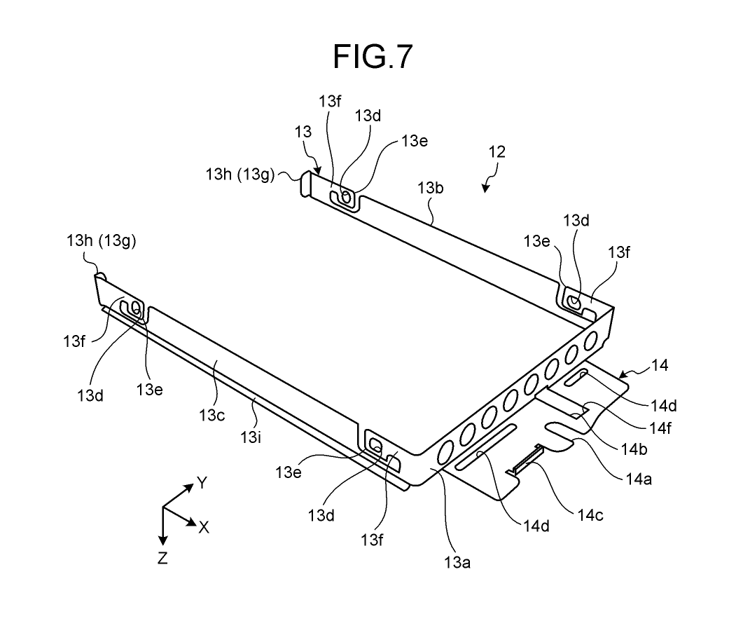

In the first embodiment, as an example, as illustrated in FIGS. 3, 4, and 7, the holder 12 comprises a surrounding portion 13 and a bracket 14 (a attaching portion, a fixed portion, a coupling portion, connected portions, a support, a guide portion, a plate-like shape portion, a flange) that are integrated with each other. The surrounding portion 13 comprises three frames 13a, 13b, and 13c (walls, plate-like portions), and has an external appearance of a C-shape (U-shape). These three frames 13a, 13b, and 13c have a band-like and plate-like (wall-like) shape having a constant height. The three frames 13a, 13b, and 13c surround three side surfaces 11c, 11d, and 11e of the module 11 (see FIG. 5), but not a side surface 11f where a connector 15 (a second connector) is provided. The surrounding portion 13 also comprises a plurality of (in the first embodiment, four, as an example) holding portions 13e. Each of the holding portions 13e has an opening 13d through which the screw 30 being a coupler for coupling the module 11 and the holder 12 is passed. Each of the holding portions 13e is connected to the frame 13b or the frame 13c via an arm 13f. The holder 12 is made of a metallic material having elasticity and conductivity (e.g., a sheet metal), as an example.

The two frames 13b and 13c extend side by side (in the first embodiment, in parallel, as an example). An end 13g of each of the frames 13b and 13c, being the end on a side of the connector 15, is bent in a direction approaching each other. In other words, the end 13g has a bent portion 13h. Each of the frames 13b and 13c also comprises a flange 13i (a reinforcing portion). The flange 13i extends along a side edge of each of the frames 13b and 13c, from the side of the connector 15 (the opposite side of the bracket 14) to the side of the bracket 14. In the first embodiment, the flange 13i extends, in the longitudinal direction, between two of the holding portions 13e arranged at both of the longitudinal ends of each of the frames 13b and 13c, and between the end 13g and the frame 13a.

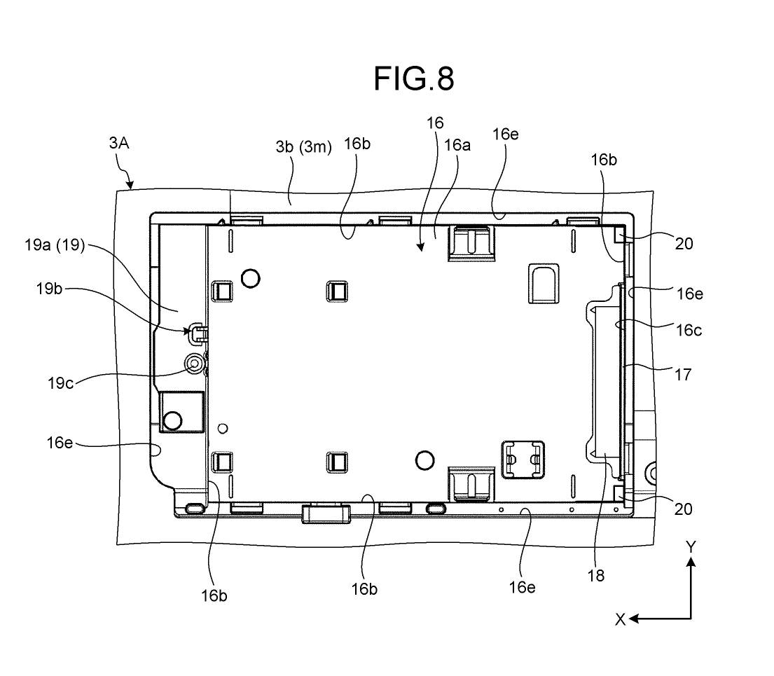

The bracket 14 is used to fix the sub-assembly 10 to the housing 3A. The bracket 14 protrudes along the first surface 11a, outwardly from the frame 13a, on the side of the first surface 11a located on the opposite side of the side surface 11c where the connector 15 is placed. The bracket 14 has a flat, plate-like shape. In the tip-side edge of the bracket 14, a cutout 14a (an opening, a penetrating portion, a slit) is formed. A screw as a fixture (not illustrated) passes through the cutout 14a. The cutout 14a opens to a direction in which the connector 15 is separated from a connector 18 (a first connector, see FIG. 8, for example) that is coupled with the connector 15 (in other words, a direction opposite to the direction in which the connector 15 and the connector 18 are coupled to each other (inserted into or engaged with the connector 18, the X direction)). The bracket 14 also comprises a slit 14b (an opening, a penetrating portion, a cutout) extending at a constant width along the direction in which the connector 15 is engaged with the connector 18 (X direction). On the tip side of the bracket 14, a claw-like projection 14c that is cut out and bent toward the second surface 11b is provided. The bracket 14 also comprises a plurality of slits 14d (openings, through holes) extending along the frame 13a (along the Y direction) linearly.

In the first embodiment, as an example, as illustrated in FIGS. 8 to 10, the sub-assembly 10 is housed in a recess 16 (a container, a module container, an opening) provided to the wall 3m of the housing 3A and having a rectangular opening in the plan view, as an example. The connector 18 implemented on a board 17 (a circuit board) is electrically connected to (coupled to, engaged with) the connector 15 implemented on the module 11. A bottom surface 16a of the recess 16 has a rectangular shape (in the first embodiment, an oblong shape, as an example) in the plan view. The connector 18 is positioned on one side surface 16b that is located on one side of the recess 16 in the X direction. The connector 18 is relatively firmly fixed to the board 17 housed in the housing 3A, and exposed (protrudes) to the inside of the recess 16 (facing the recess 16) through an opening 16c formed on the side surface 16b. There is a gap, at least partially, between each of the side surfaces 16b that are positioned on both sides of the recess 16 in the Y direction and each side surface 13j of the sub-assembly 10 that is placed in the recess 16. On the other side surface 16b of the recess 16, a guiding member (e.g., an elastic member) for guiding (moving) the sub-assembly 10 when the connector 15 is inserted into the connector 18, or a member functioning as a conductive member for grounding the sub-assembly 10 may be provided.

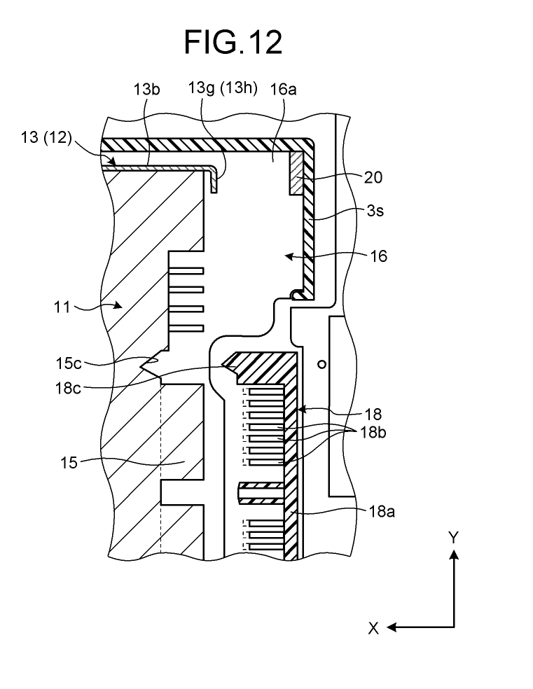

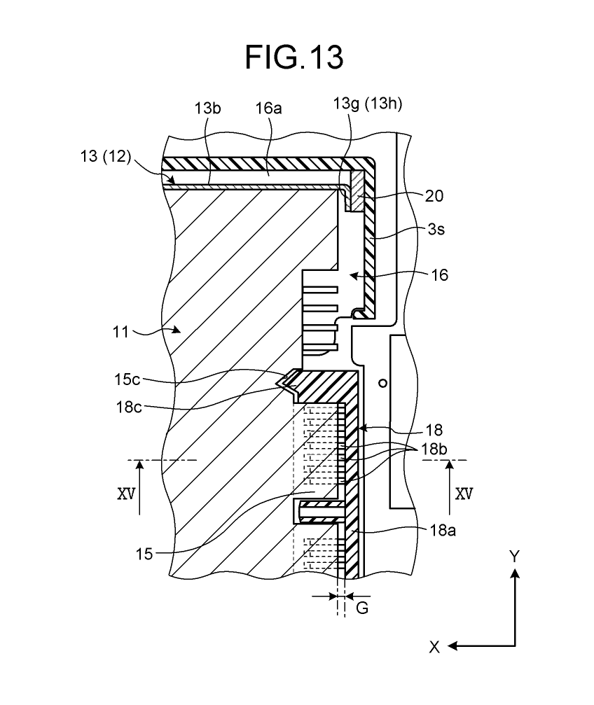

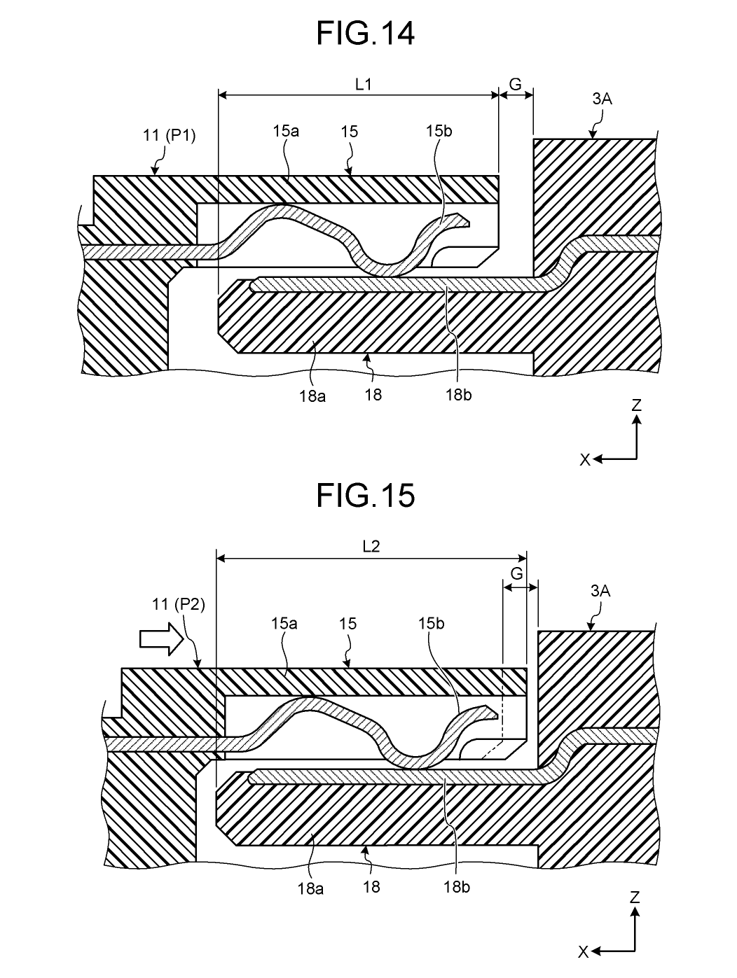

In the first embodiment, as an example, the connector 18 is configured as a flat female connector that is long in the Y direction. The connector 18 comprises a base 18a extending along the Y direction and a plurality of terminals 18b lined up in the Y direction, as illustrated in FIGS. 12 and 13. The board 17 is housed in the housing 3A, and is fixed to the housing 3A with screws (not illustrated), for example. The connector 15 is configured as a flat male connector that is long in the Y direction, and comprises a base 15a extending along the Y direction and a plurality of terminals 15b lined up in the Y direction, as illustrated in FIGS. 14 and 15.

On the other end of the recess 16 in the X direction, a stepped portion 19 extending approximately in parallel with the bottom surface 16a is provided between the bottom surface 16a and the edge of the opening of the recess 16. In a configuration in which the sub-assembly 10 is housed in the recess 16, a rear surface 14e (see FIG. 4) of the bracket 14 is held in contact with a top surface 19a of the stepped portion 19. The connector 15 provided on the side surface 11c is fitted with respect to and attached to the connector 18 exposed to the recess 16. The connector 18 and the connector 15 are coupled in the longitudinal direction of the sub-assembly 10 (X direction).

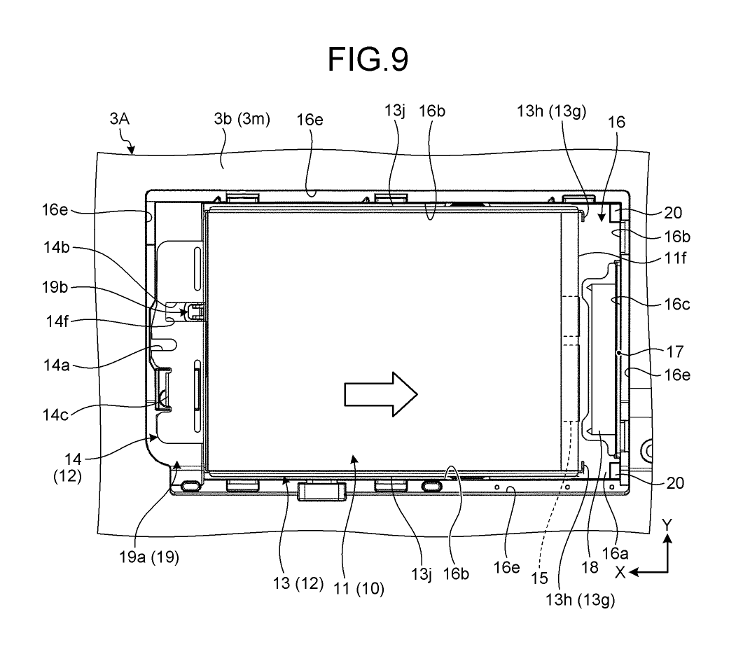

As illustrated in FIG. 9, in an initial configuration after the sub-assembly 10 is inserted into the recess 16, the sub-assembly 10 is placed closer to a side that is opposite to where the connector 18 is provided inside the recess 16. The rear surface 14e of the bracket 14 abuts against the top surface 19a of the stepped portion 19, and an engaging portion 19b (a protrusion, a projection, a contacting portion, a hook portion, a stopper) protruding from the stepped portion 19 passes through the slit 14b. The width of the engaging portion 19b is slightly smaller than the width of the slit 14b.

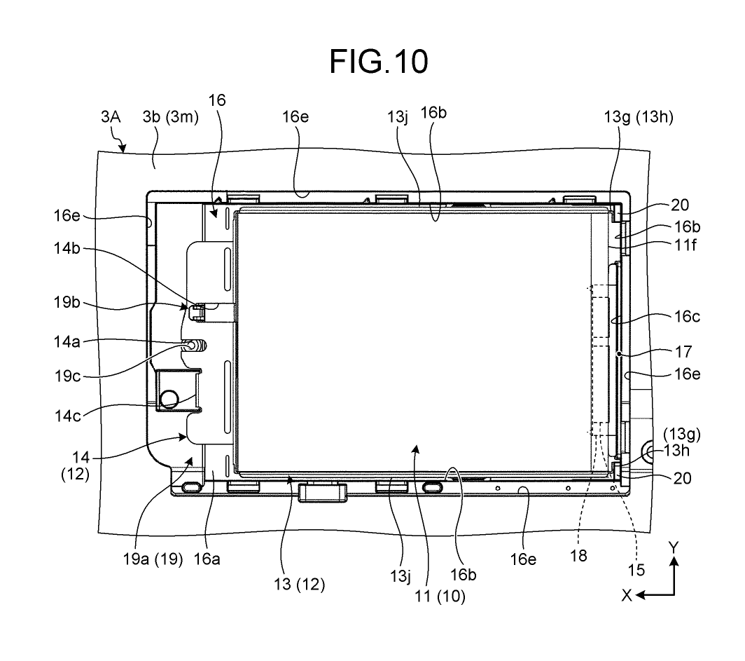

When a worker slides the sub-assembly 10 toward the connector 18 (to the right side in FIGS. 9 and 10) while pressing down the sub-assembly 10 to the bottom of the recess 16 (toward the bottom surface 16a), the connector 15 is fitted into the connector 18. At the same time, on the opposite side of these connectors, the engaging portion 19b is engaged with an engaging portion 14f (an edge portion, a stopper) provided on the slit 14b that is positioned on the opposite side of the connector 15. In this manner, the sub-assembly 10 is placed in and temporarily held by the recess 16 (without being fixed with the screws 30 and the like being couplers).

As the sub-assembly 10 is moved from the position illustrated in FIG. 9 to the position illustrated in FIG. 10, the connector 18 and the connector 15 move from the respective positions illustrated in FIG. 12 to the positions illustrated in FIG. 13. As illustrated in FIGS. 12 and 13, components 20 are provided on the side surface 16b of the recess 16 (wall 3s of the housing 3A forming the recess 16), at positions facing the respective bent portions 13h each of which is provided to the corresponding end 13g of the frame 13b of the holder 12. In a configuration in which the sub-assembly 10 is mounted on the housing 3A as illustrated in FIG. 8, the ends 13g of the holder 12 abut against the components 20, respectively. In this manner, the components 20 are capable of functioning as members for aligning the ends 13g, and aligning the sub-assembly 10.

In the first embodiment, as an example, as illustrated in FIG. 13, when the sub-assembly 10 is mounted on the housing 3A, the connector 15 is not fully inserted into the deepest part of the connector 18, and a gap G is provided between the connector 18 and the connector 15. Although the gap G is provided between the connector 18 and the connector 15, the terminals 18b on the connector 18 and the terminals 15b on the connector 15 are still electrically connected, as illustrated in FIG. 15.

Each of the components 20 is a relatively hard member, e.g., made of a metallic material. Therefore, even when an inertial force acts on the sub-assembly 10 from the left side to the right side in FIG. 10, e.g., when the housing 3A is dropped, or even when an external force is applied to the sub-assembly 10 from the right side in FIG. 10, the load is communicated to the ends 13g of the holder 12 via the components 20. The components 20 are examples of a stiff body or a load communicating member. In the first embodiment, as an example, the arms 13f are examples of a narrow portion that is narrower (with a smaller cross-section area) than other part of the holder 12, are examples of a stress concentrating portion, or are an examples of a fragile portion that is fragile relatively to the other part (general part) of the holder 12. If a load is communicated to the ends 13g of the holder 12 via the components 20, the stress is more concentrated on the arms 13f being narrow portions. Therefore, the holder 12 including the arm 13f will be plastically deformed more easily. The plastic deformation mentioned herein means an irreversible deformation (permanent deformation), not an elastic deformation that is reversible after deformation. A plastic deformation is not limited to a bent such as buckling, but also may be a rupture or an extension, for example.

As described above, in the first embodiment, the gap G is provided between the connector 18 and the connector 15. Therefore, in the first embodiment, because the connector 18 and the connector 15 abut against each other (are propped by each other), a deformation of the arm 13f can be prevented from being interrupted.

In other words, as illustrated in FIGS. 14 and 15, as the arms 13f are buckled (deformed, plastically deformed, bent), the module 11 and the connector 15 are moved from a first position P1 (a first position, an initial position, a mounted position) to a second position P2 (a second position, a moved position), in relation to the housing 3A. The first position P1 is the initial position where the module 11 is positioned after the sub-assembly 10 is inserted into the housing 3A, and where the connector 15 is relatively loosely inserted into the connector 18. The second position P2 is a position of the module 11 that is closer to the connector 18, and where the connector 15 is inserted into the connector 18 relatively deeper than in the first position P1. In other words, the module 11 as a module is movable at least between the first position P1 and the second position P2, and the arms 13f being a shock absorber are buckled (deformed, plastically deformed, or bent) as the module 11 being a module moves from the first position P1 to the second position P2 (moved relatively). Being movable herein means not being movable in a normal condition, but means that the module becomes movable in an abnormal condition, e.g., when the television receiver 1A as an electronic device is dropped, that is, a load acting on the arms 13f being a shock absorber or a stress caused thereby exceeds a predetermined threshold (e.g., a limit, a yield point, 0.2 percent proof stress).

A length L2 in which the connector 18 and the connector 15 are fitted with respect to each other (coupled length, the length at which the one is on top of the other) at the second position P2 is longer than a length L1 (coupled length, the length at which the one is on top of the other) in which the connector 18 and the connector 15 are engaged at the first position P1 (L1<L2). It is preferable for the second position P2 to be the deepest position where the connector 15 can be inserted into the connector 18, which is determined by the structures of the connector 18, the connector 15, and other parts, or to be a position more in the front side of the deepest position in the inserting direction. In other words, the engaging length L2 is preferably equal to or shorter than an engaging length L3 (not illustrated) at the deepest position (most rear position) (L2≦L3). This is because, if the connector 15 is inserted further into the connector 18 exceeding the deepest position, the connector 18, the connector 15, or other parts may get damaged. The deepest position may be defined as a position at which an engaging portion 18c (an abutting portion) arranged as a projection, for example, on the connector 18 abuts against and engaged with an engaging portion 15c (an abutting portion) provided as, for example, a recess on the connector 15, (an abutting position, an engaging position), but is not limited thereto.

In the first embodiment, in both of the configuration in which the sub-assembly 10 is mounted on the housing 3A (that is, a configuration in which the connector 18 and the connector 15 are fitted with respect to each other with the gap G therebetween, a configuration in which the module 11 is located at the first position P1) illustrated in FIG. 14 and the configuration illustrated in FIG. 15 in which the connector 15 is fitted deeper into the connector 18 as the arms 13f are deformed (the arrangement in which the module 11 is at the second position P2), and in configurations between these two configurations as well, the terminals 18b on the connector 18 and the terminals 15b on the connector 15 are kept in contact with each other and kept continuous, and are electrically connected to each other. In other words, the board 17 is kept electrically connected to the module 11 via the connector 18 and the connector 15. Therefore, even when the arms 13f are deformed because some shock is applied to the housing 3A, for example, the electrical connection between the module 11 and the circuit board (not illustrated) is maintained, and, therefore, operations of the television receiver 1A (accesses to the module 11) is less interrupted, advantageously. It is more preferable for the board 17 to be kept electrically connected to the module 11 via the connector 18 and the connector 15, even when the module 11 comes to the deepest position.

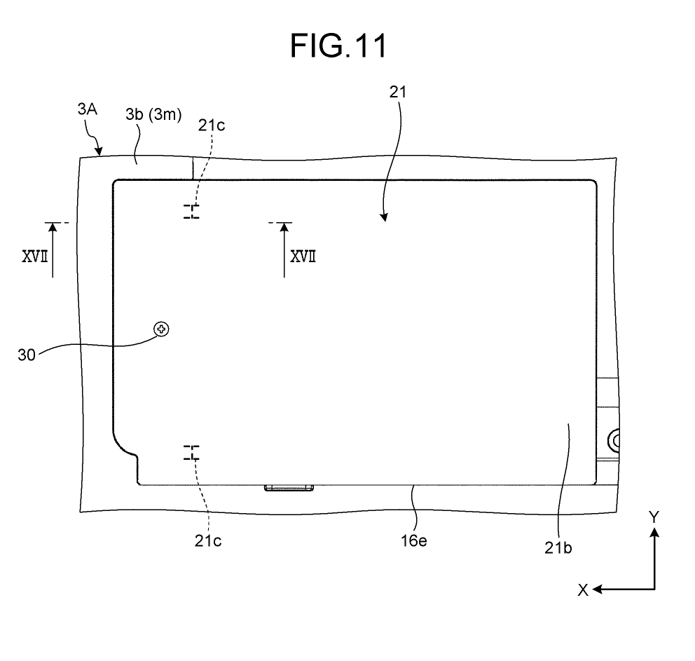

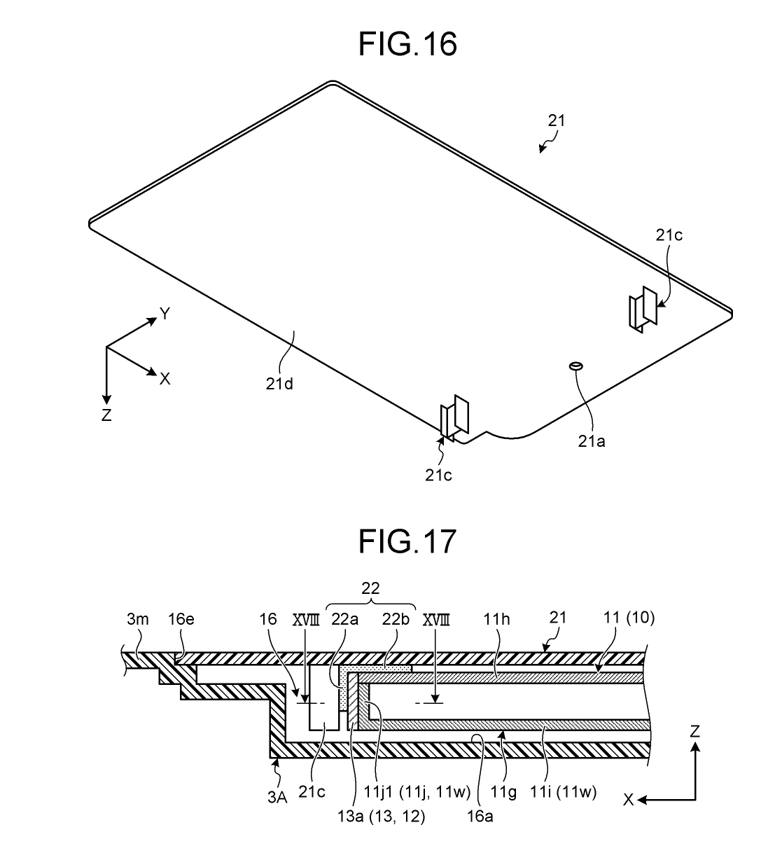

In the first embodiment, as an example, as illustrated in FIG. 11, a lid member 21 (a cover, a covering member, plate-like member, a plate, a wall, a member, a part) for covering the recess 16 is provided. The lid member 21 has a rectangular, plate-like shape. The lid member 21 is attached to an opening 16e, to close the recess 16. The lid member 21 faces the second member 11h (a third wall) of the housing 11w. The lid member 21 comprises a coupling portion 21a (in the first embodiment, an opening, as an example), as illustrated in FIG. 16. The lid member 21 and the housing 3A are coupled by a coupler 30 (see FIG. 11) passed through the coupling portion 21a from a surface 21b (a frontal surface, a first surface) of the lid member 21, and are coupled to a coupling portion 19c of the housing 3A. This coupler 30 also passes through the cutout 14a on the bracket 14. In other words, by coupling the coupler 30 to the coupling portion 19c, the bracket 14, and the module 11 in turn, are fixed to the housing 3A, while holding the bracket 14 between the housing 3A and the lid member 21. In the first embodiment, as an example, the cutout 14a extends in a direction in which the connector 15 and the connector 18 are brought closer to each other or separated from each other (in the X direction). When the module 11 is at the first position P1, the coupler 30 is not in contact with (does not interfere with) a longitudinal end (edge) of the cutout 14a. Therefore, the coupler 30 functions as a resistance against a relative movement of the module 11 with respect to the housing 3A in the X direction, without functioning as a stopper for stopping such a movement in the X direction when an abnormal (shocking) external force (an inertial force, for example) is applied to the module 11, e.g., when the housing 3A is dropped.

In the first embodiment, as an example, a relative movement of the module 11 with respect to the housing 3A in the direction in which the connectors 15 and 18 are separated from each other (in the left direction in FIGS. 9 to 15) is suppressed by protrusions 21c (suppressors) that are fixed to the housing 3A, or provided to the lid member 21 that is a portion of the housing 3A. The protrusions 21c prevent the connectors 15 and 18 from separating from each other, and from being electrically disconnected. In the first embodiment, as an example, as illustrated in FIGS. 16 and 17, each of the protrusion 21c protrudes from a surface 21d (a rear surface, a second surface) of the lid member 21, the surface located opposite the connector 18 with respect to the connector 15 (in the first embodiment, as an example, on the opposite side of the connector 18 in the housing 11w; on the left side in FIG. 17) into the recess 16, and faces the wall 11j of the housing 11w and the frame 13a of the holder 12. In the first embodiment, as an example, each of the protrusions 21c has an H-shape. In this manner, a sectional secondary moment can be further increased, and the protrusions 21c being relatively light-weighted and having a relatively stiff structure can be achieved.

In the first embodiment, as an example, a buffering member 22 (a shock absorber, a buffering structure) is provided between the frame 13a and each of the protrusion 21c in a configuration where the module 11 is at the first position P1. The buffering member 22 may be made of a synthetic resin material, a foamed material made of a synthetic resin, or an elastomer, for example. The buffering members 22 prevent (buffer) a force (load) applied from the lid member 21 from acting on the housing 11w (the first member 11g and the second member 11h) of the module 11 through the protrusions 21c. As mentioned earlier, the shaft 11p rotatably supporting the arm 11r extends between the wall 11i of the first member 11g and the second member 11h. In other words, the ends of the shaft 11p are supported by the wall 11i and the second member 11h, respectively. Therefore, it has been found that, by researches conducted by the inventors, when an excessive (shocking) external force (inertial force) is applied to the module 11, e.g., when the housing 3A is dropped, reading or writing performed by the head 11t might fall into an abnormal condition, because of the external force communicated through the protrusions 21c to the second member 11h (because the reactive force of the inertial force acts on the module 11). In the first embodiment, as an example, because the buffering members 22 buffer (reduce) the force (load) acting on the housing 11w (the second member 11h) through the protrusion 21c, reading or writing performed by the head 11t is prevented from falling into an abnormal condition, compared with when the buffering members 22 are not provided.

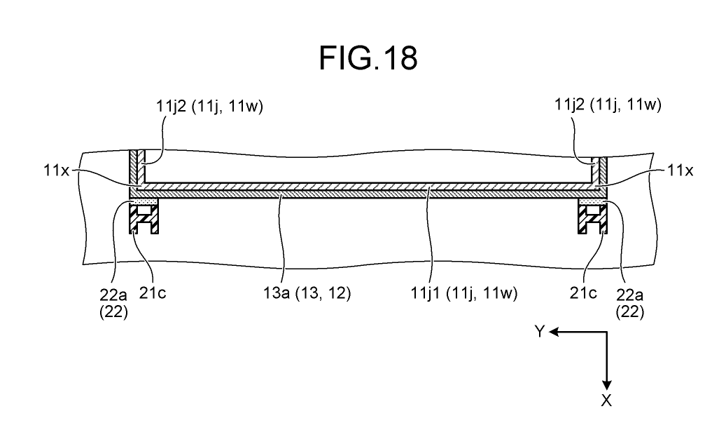

In the first embodiment, as an example, as illustrated in FIG. 18, each of the protrusions 21c face a corresponding corner 11x of the housing 11w. Among the walls 11j, a wall 11j1 (first wall) faces the protrusions 21c and intersects with the direction in which the connector 15 and the connector 18 are coupled to each other (in the first embodiment, the direction perpendicularly intersecting with the direction the connector 15 is coupled with the connector 18, the Y direction; the left and right direction in FIG. 18, as an example), and walls 11j2 (second walls) extend in a direction perpendicularly intersecting with the direction in which the connector 15 and the connector 18 are coupled to each other (the X direction; the up and down direction in FIG. 18). The wall 11j1 and the walls 11j2 are connected at the corners 11x. The walls 11j2 are connected to longitudinal ends of the wall 11j1 (ends in the left and right direction in FIG. 18) (the corners 11x). Therefore, according to the first embodiment, as an example, a force applied in the direction in which the connector 15 and the connector 18 are coupled to each other is communicated through the protrusion 21c to the walls 11j2. Therefore, as an example, because the force is communicated to the walls 11j2, force (component of the force) acting on the second member 11h is reduced by that amount. Therefore, abnormalities in reading or writing performed by the head 11t are reduced. Because the protrusions 21c (suppressor) face the corners 11x, a certain effect can be achieved even without the buffering members 22.

In the first embodiment, as an example, each of the buffering members 22 comprises a first part 22a and a second part 22b, as illustrated in FIG. 17. The first part 22a is provided between the protrusion 21c and the wall 11j1 (and the frame 13a). The second part 22b is provided between the second member 11h and the lid member 21, and is connected to the first part 22a. The buffering member 22 adheres to and is thus attached to the module 11, for example. The protrusions 21c are inserted into the recess 16, as the recess 16 is covered by the lid member 21. If the protrusion 21c entering the recess 16 interferes with the first part 22a, the first part 22a (the buffering member 22) might get separated (peeled off, fall off) from the module 11. In the first embodiment, because the buffering member 22 comprises the second part 22b, as an example, even if the protrusion 21c interferers with the first part 22a, the first part 22a can be prevented from being pulled out from the second part 22b and being removed from the module 11. It is preferable for the module 11 and the lid member 21 (the housing 3A) to be electrically connected via the buffering members 22 and the protrusions 21c, and a ground potential is shared between the module 11 and the lid member 21, as an example. To share the ground potential, the housing 3A, the lid member 21, the protrusion 21c, the buffering member 22, the frame 13a, the holder 12, the housing 11w, and the like may be made of a conductive material (e.g., a metallic material with a conductive property), or a conductive member may be provided, at least partially, to an area that is brought into contact with other parts. In the latter configuration, a conductive film or tape may adhere to the part, to provide the parts with a conductive area.

In the first embodiment, as an example, a plurality of components (elements, electronic components, electric components) are housed in the housing 3A. Components 9 and the like implemented on the board 17 form at least a portion of a controlling circuit (not illustrated). The controlling circuit may include a video signal processing circuit, a tuner, a high-definition multimedia interface (HDMI) signal processor, an audio-video (AV) input terminal, a remote controller signal receiver, a controller, a selector, an on-screen display interface, a storage (e.g., a read-only memory (ROM), a random access memory (RAM), a hard disk drive (HDD)), and an audio signal processing circuit. The controlling circuit controls video outputs (e.g., moving images or still images) from the display screen 4a of the display device 4, sound outputs from a speaker (not illustrated), and light emissions from a light emitting diode (LED) (not illustrated). The display device 4, the speaker, the LED, and the like are examples of an output module.

As described above, in the first embodiment, as an example, the protrusions 21c (suppressors) and the buffering members 22 are provided. The protrusions 21c (suppressors) are provided to the lid member 21, and protrude into the container 16 to prevent the connector 15 and the connector 18 from being separated from each other and electrically disconnected with respect to each other. The buffering members 22 are provided on the housing 11w, and prevent a force applied to the lid member 21 from impacting the second member 11h via the protrusions 21c. Therefore, according to the first embodiment, as an example, the connectors 15 and 18 are prevented from being electrically disconnected, and the module 11 falls into fewer abnormal conditions. Furthermore, as an example, the buffering members 22 prevent the protrusions 21c from being damaged by a force applied to the module 11. Furthermore, because the protrusions 21c are provided on the lid member 21, the protrusions 21c does not affect at all when the module 11 is slid (moved) when the module 11 is mounted on the housing 3A without the lid member 21, as an example.

Furthermore, in the first embodiment, as an example, the protrusions 21c face the longitudinal ends (the corners 11x) of the wall 11j1. Therefore, according to the first embodiment, as an example, because a force (load) applied to the module 11 via the protrusions 21c in the direction in which the connector 15 and the connector 18 are coupled to each other is communicated to the walls 11j2, a force communicated to the second member 11h is reduced. Therefore, as an example, the module 11 falls into fewer abnormal conditions that are caused by the force being communicated to the second member 11h.

Furthermore, in the first embodiment, as an example, each of the buffering members 22 comprises the first part 22a and the second part 22b. Therefore, the second part 22b prevents the first part 22a from moving from a predetermined position.

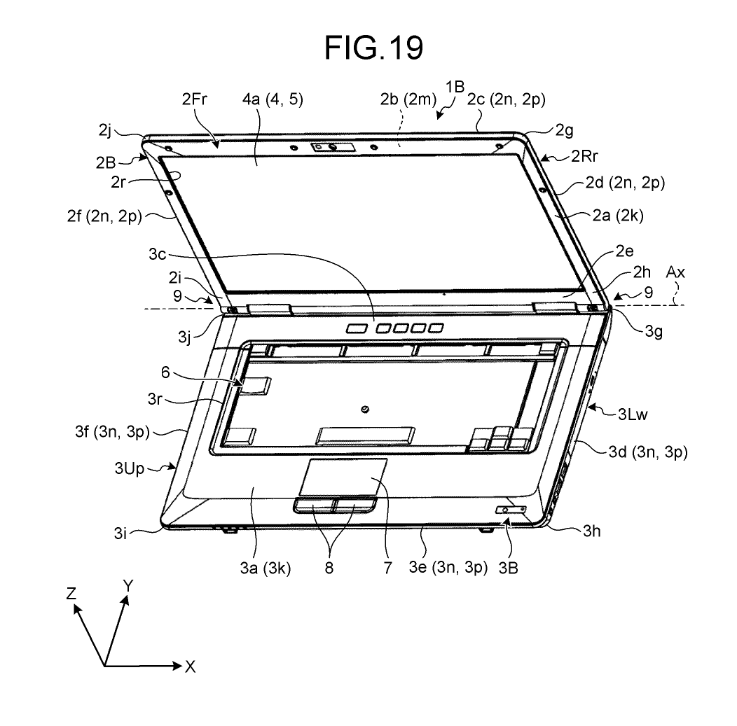

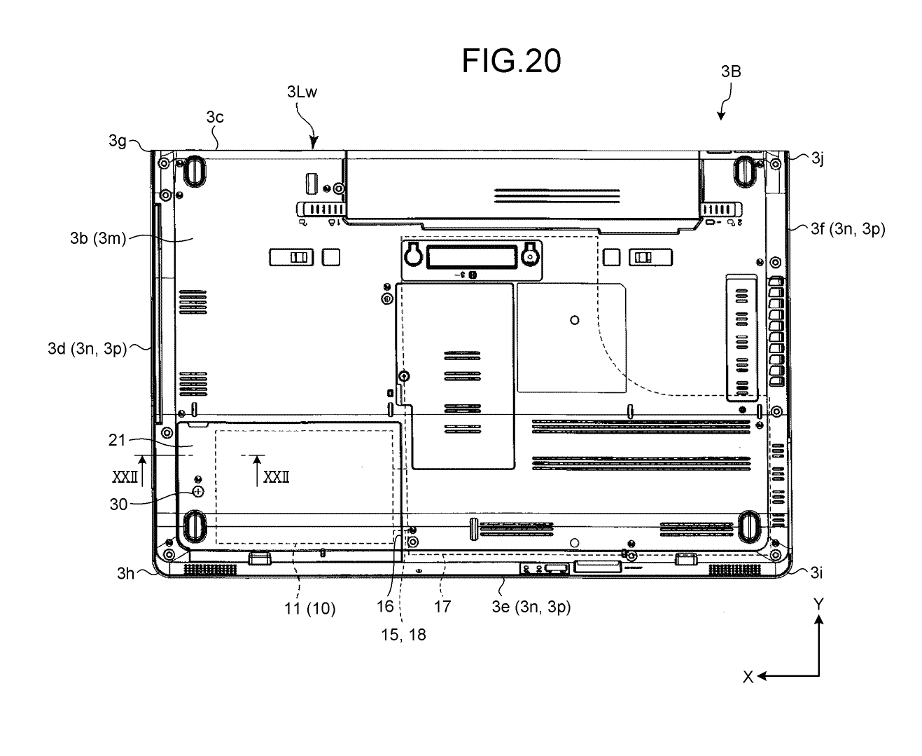

An electronic device 1B according to a second embodiment is a so-called laptop (clamshell) computer, as an example. In the second embodiment, the electronic device 1B comprises a first housing 3B (a housing) and a second housing 2B (another housing) as illustrated in FIG. 19, as an example. The board 17 (see FIG. 20) is housed in the first housing 3B (a first part), and at least a portion of the display device 4 is housed in the second housing 2B (a second part). A keyboard 6 (an input operation module, an input receiving module, an input module), a touchpad 7 (an input operation module, an input receiving module, an input module), and click buttons 8 (an input operation module, an input receiving module, an input module) are provided to the first housing 3B.

The first housing 3B and the second housing 2B are connected rotatably by a hinge 9 (a connected portion, a linking portion, a rotatable support, a hinge mechanism, a connecting mechanism, a linking mechanism, a rotatably supporting mechanism). The first housing 3B and the second housing 2B are connected by the hinge 9 rotatably between an opened configuration illustrated FIG. 19 and a folded configuration not illustrated. In the second embodiment, as an example, the hinge 9 connects the first housing 3B and the second housing 2B rotatably about a rotation axis Ax. The display screen 4a of the display device 4 is exposed through an opening 2r formed on a surface 2a (a frontal surface, a surface, a surface portion) of the second housing 2B. The keyboard 6, the touchpad 7, the click buttons 8, and the like are exposed on a surface 3a (an upper surface, a frontal surface, a first surface, a first surface portion) of the first housing 3B. When the electronic device 1B is folded, the surface 3a of the first housing 3B is brought into contact with the surface 2a of the second housing 2B, and the display screen 4a, the keyboard 6, the touchpad 7, the click buttons 8, and the like are hidden by the first housing 3B and the second housing 2B. When the electronic device 1B is opened, the surface 3a of the first housing 3B and the surface 2a of the second housing 2B are exposed, whereby the display screen 4a, the keyboard 6, the touchpad 7, the click buttons 8, and the like are available for use (for viewing and operations). In FIG. 19, only some keys in the keyboard are illustrated.

In the second embodiment, as an example, as may be understood from FIG. 19, the second housing 2B has an external appearance of a rectangular shape (in the second embodiment, an oblong shape, as an example) in front view and the rear view. In the second embodiment, as an example, the second housing 23 has a cuboid shape that is flat in the front-back direction (the thickness direction of the second housing 2B). The second housing 2B has the surface 2a, and a surface 2b (a rear surface, a back surface, a surface portion) located on the opposite side of the surface 2a. The surface 2a and the surface 2b are laid approximately in parallel (in the second embodiment, in parallel, as an example). The second housing 2B also has four ends 2c to 2f (a side portion, an edge portion) and four corners 2g to 2j (a pointed portion, a curved portion, an end) in the front view. The ends 2c and 2e are examples of a longer side. The ends 2d and 2f are examples of a shorter side.

The second housing 2B also comprises a wall 2k (a part, a plate, a frame, a front wall, a frontal wall, a top wall) including the surface 2a, and a wall 2m (a part, a plate, a rear wall, a back wall, a bottom wall) including the surface 2b. The walls 2k and 2m both have a rectangular shape (in the second embodiment, an oblong shape, as an example). The wall 2k also has a frame-like shape, and the wall 2m has a plate-like shape. The second housing 2B also comprises four walls 2n (parts, plates, side walls, end walls, standing walls, stretched portions) each of which includes a surface 2p (a side surface, a circumferential surface) stretching across the wall 2k and the wall 2m. A rectangular opening 2r is provided to the wall 2k.

The second housing 2B is made from a combination of a plurality of parts (divided portions, a member). The second housing 2B comprises a first member 2Fr (a first part, a front side member, a cover, a bezel, a frame) at least including the wall 2k, and a second member 2Rr (a second part, a rear side member, a base, a bottom, a plate, a cover) at least including the wall 2m, as an example. In the second embodiment, as an example, the walls 2n are configured as a part of the second member 2Rr. The first member 2Fr, the second member 2Rr, and the like may be made of a metallic material or a synthetic resin material, for example.

In the second embodiment, as an example, the display device 4 (a display module, a display, a panel, a display component) is housed in the second housing 2B. Specifically, the display screen 4a of the display device 4 located on the side of the surface 2a is exposed to the front side (outside) of the second housing 2B through the opening 2r. A user can view the display screen 4a from the front side through the opening 2r. The display device 4 has an external appearance of a rectangular shape (in the second embodiment, an oblong shape, as an example) in the front view. The display device 4 also has a cuboid shape that is thin and flat in the front-back direction. The display device 4 is an LCD, an OELD, or a PDP, for example.

In the second embodiment, as an example, a transparent, relatively thin, and rectangular input operation panel 5 (as an example, a touch panel, a touch sensor, an operation surface, an input operation module, an input receiving module) is provided to the front side (frontal side, the side of the wall 2k) of the display device 4. The input operation panel 5 covers the display screen 4a. An operator (e.g., a user) can make inputs by making operations such as touching, pressing, rubbing the input operation panel 5, or moving a hand, a finger, or a stylus near the input operation panel 5. Light output from the display screen 4a of the display device 4 passes through the input operation panel 5 and travels to the front side (outside) of the second housing 2B through the opening 2r on the wall 2k. The input operation panel 5 is an example of an input module. In the first embodiment, as an example, the display device 4 and the input operation panel 5 are fixed to (supported by) one of the first member 2Fr and the second member 2Rr with fixtures (fixing parts, clamps; e.g., screws, clamps, or parts, not illustrated), an adhesives (e.g., an adhesive agent, or a double-sided adhesive tape, not illustrated), and the like.

In the second embodiment, as may be understood from FIGS. 19 and 20, the first housing 3B has an external appearance of a rectangular shape (in the second embodiment, an oblong shape, as an example) in the front view and the rear view, as an example. In the second embodiment, the first housing 3B has a cuboid shape that is flat in the up and down direction (the thickness direction of the first housing 3B, Z direction), as an example. The first housing 3B has a surface 3a (an upper surface, a frontal surface, a surface portion), and a surface 3b (a bottom surface, a back surface, a surface portion) located on the opposite side of the surface 3a. The surface 3a and the surface 3b are laid approximately in parallel (in the second embodiment, in parallel, as an example). The first housing 3B has four ends 3c to 3f (side portions, edge portions) and four corners 3g to 3j (pointed portions, curved portions, ends) in the plan view. The ends 3c and 3e are examples of a longer side. The ends 3d and 3f are examples of a shorter side. As an example, the first housing 3B functions as an container for housing components such as the board 17, and may also function as a support for supporting an object with some weight (e.g., a component).

The first housing 3B also has a wall 3k (a part, a plate, a frame, an upper wall portion, a frontal wall, a top wall) including the surface 3a, and a wall 3m (a part, a plate, a bottom wall, a back wall, a bottom wall) including the surface 3b. The walls 3k and 3m both have a rectangular shape (in the second embodiment, an oblong shape, as an example). The wall 3k also has a frame-like shape, and the wall 3m has a plate-like shape. The first housing 3B also has four walls 3n (parts, plates, side walls, end walls, standing walls, stretched portions) each of which includes a surface 3p (a side surface, a circumferential surface) stretching across the wall 3k and the wall 3m. A rectangular opening 3r is provided to the wall 3k.

The first housing 3B is made from a combination of a plurality of components (divided portions, members). The first housing 3B comprises a first member 3Up (a first part, an upper member, a cover, a mask, a plate) including at least the wall 3k, and a second member 3Lw (a second part, a lower member, a base, a bottom, a plate, a cover) including at least the wall 3m, as an example. In the second embodiment, the walls 3n are configured as a part of the second member 3Lw, as an example. The first housing 3B may comprise a third member (a third part, an intermediate member, an inner, a middle frame, a middle plate, not illustrated) interposed between the first member 3Up and the second member 3Lw, in addition to the first member 3Up and the second member 3Lw. Some part of the walls 3k, 3m, and 3n may be included as a part of the third member. The first member 3Up, the second member 3Lw, the third member, and the like may be made of a metallic material or a synthetic resin material, for example.

In the second embodiment, as an example, one or more boards 17 (circuit boards, control boards, main boards, electric components) are housed in the first housing 3B, as illustrated in FIG. 20. The board 17 is provided side by side with the keyboard 6 (see FIG. 19) (in the second embodiment, in parallel, as an example).

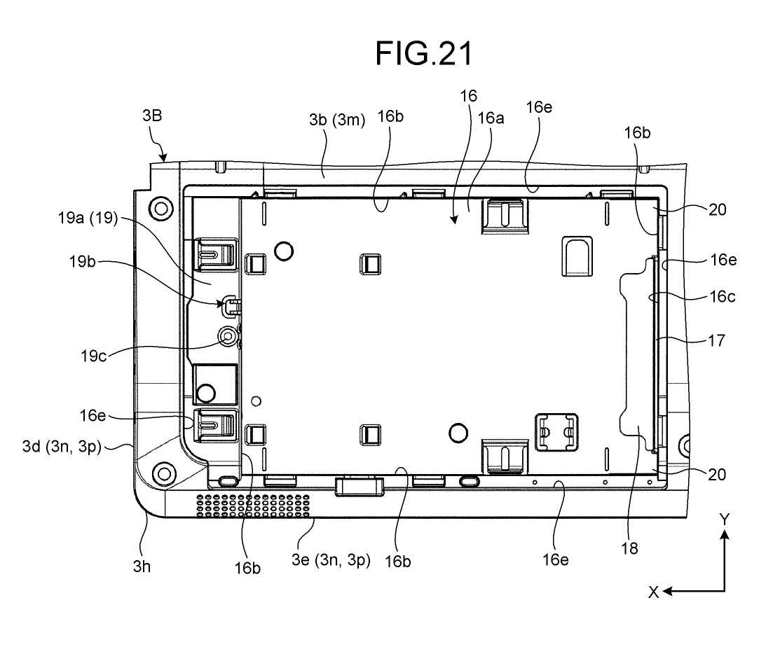

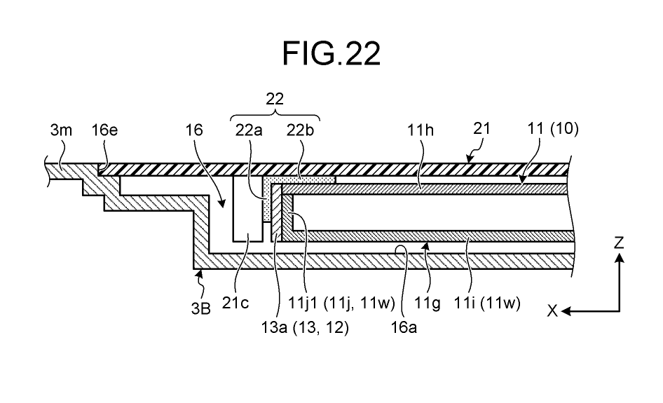

In the second embodiment, as an example, the same container 16 as that in the first embodiment is provided near the corner 3h of the wall 3m included in the first housing 3B, as illustrated in FIG. 21. The same module 11 (sub-assembly 10) as that in the first is housed in container 16. The opening 16e of the container 16 is covered by the same lid member 21 as that in the first embodiment. In the second embodiment as well, the same protrusions 21c and buffering members 22 as those in the first embodiment are provided, as illustrated in FIG. 22, as an example.

In the second embodiment, as an example, a plurality of components (not illustrated) such as a central processing unit (CPU), a graphic controller, power circuit components, a platform controller hub (PCH), a memory slot connector, an LCD connector, an input/output (I/O) connector, a power coil, an element, and a connector can be implemented on the board 17. A controlling circuit may include a video signal processing circuit, a tuner, an HDMI signal processor, an AV input terminal, a remote controller signal receiver, a controller, a selector, an on-screen display interface, a storage (e.g., a ROM, a RAM, an HDD, and a solid state drive (SSD)), and an audio signal processing circuit. The controlling circuit controls video outputs (e.g., moving images or still images) from the display screen 4a of the display device 4, sound outputs from a speaker (not illustrated), and light emissions from a light emitting diode (LED) (not illustrated). The display device 4, the speaker, the LED, and the like are examples of an output module.

The electronic device 1B according to the second embodiment described above comprises the same container 16 and the same module 11 as those in the television receiver 1A in the first embodiment, and the same protrusions 21c (suppressors) and the same buffering members 22 (a shock absorber) associated with the container 16 and the module 11. Therefore, the same results as those achieved in the first embodiment can be achieved.

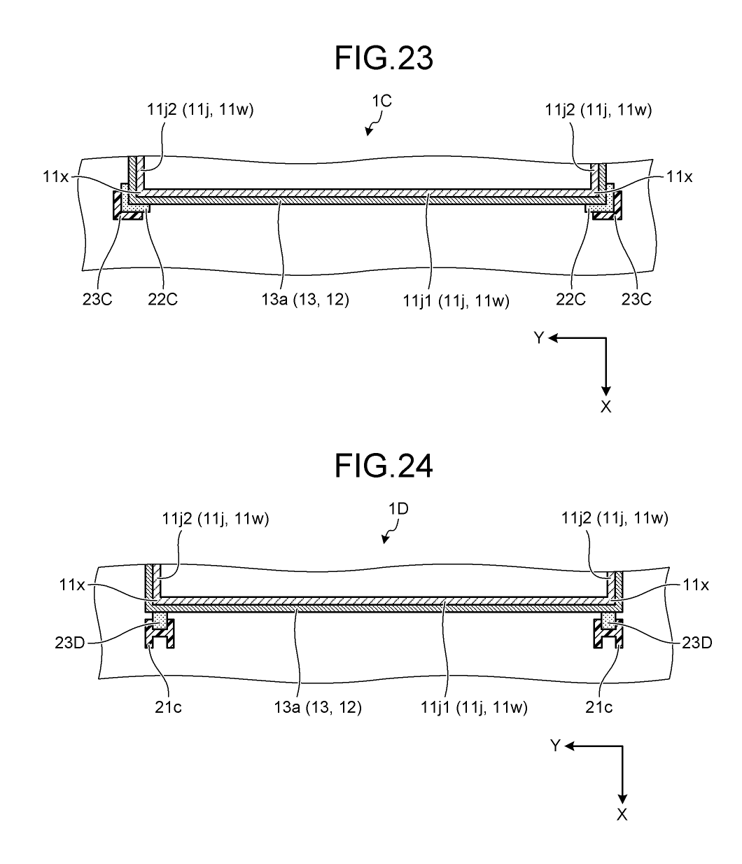

An electronic device 1C according to a first modification has a similar structure as those according to the embodiments described above. Therefore, in the first modification, the same results as those achieved in the embodiments can be achieved, as an example, because of the similar structure as those according to the embodiments. In the electronic device 10 according to the first modification, however, L-shaped suppressors 23C are provided, as an example, instead of the H-shaped protrusions 21c (suppressors) provided in the embodiments described above, as illustrated in FIG. 23. The suppressors 23C are positioned to face the corners 11x of the housing 11w, and also face the two walls 11j1 and 11j2 that are connected to each other at the corners 11x. An L-shaped buffering member 22C (a shock absorber, a buffering structure) is interposed between the walls 11j1 and 11j2 connected in an L-shape to each other and the corner 11x of the housing 11w. A structure comprising the suppressors 23C and the buffering members 22C described above can also achieve the same results as those achieved in the embodiments described above. In the first modification, the suppressors 23C and the buffering members 22C face or kept in contact with the two walls 11j1 and 11j2 extending in directions intersecting each other. In other words, the buffering members 22C can buffer a force (load) in a direction in which the connector 15 and the connectors 18 (see FIGS. 9 and 10, for example) are disconnected (a direction opposite to the direction in which the connector 15 and the connector 18 are coupled to each other), but also can buffer a force in a direction intersecting with (in the first modification, the direction perpendicular to, as an example) the coupling direction, as an example. Therefore, according to the first modification, as an example, the number of parts and production labors can be reduced compared with when separate buffering members are arranged in each of these directions. The suppressors 23C may be arranged on the lid member 21, or may be arranged on the bottom surface 16a (wall) of the recess 16.

An electronic device 1D according to a second modification has a similar structure as those according to the embodiments and the first modification described above. Therefore, in the second modification, the same results as those achieved in the embodiments and the modification can be achieved, as an example, because of the similar structure as those according to the embodiments and the first modification. In the electronic device 1D according to the second modification, however, as an example, suppressors 23D are provided between each of the H-shaped protrusions 21c that are the same as those according to the first and the second embodiments and the corner 11x of the wall 11j1, and surrounded by the two vertical elements and a horizontal element in the H-shape, as illustrated in FIG. 24. A structure including the suppressors 23D can also achieve the same results as those according to the embodiments and the first modification. Furthermore, according to the second modification, as an example, additional advantageous effects can be achieved, e.g., the suppressors 23D are less easily displaced (can be aligned more easily), and the suppressors 23D can absorb an impact more, because the suppressors 23D have a larger volume. The suppressors 23D may be provided to the lid member 21, or on the bottom surface 16a (wall) of the recess 16.

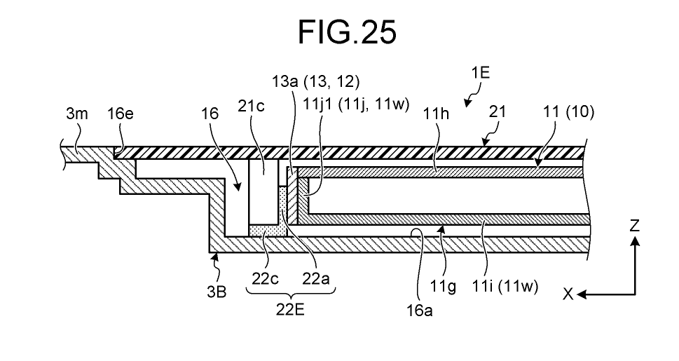

An electronic device 1E according to a third modification has a similar structure as those according to the embodiments and the modifications described above. Therefore, in the third modification as well, the same results as those achieved in the embodiments and the modifications can be achieved, as an example, because of the similar structure as those according to the embodiments and the first modifications. In the electronic device 1E according to the third modification, however, as an example, buffering members 22E (shock absorbers, buffering structures) each comprising the first part 22a and a second part 22c is provided, as illustrated in FIG. 25, instead of the buffering members 22 each comprising the first part 22a and the second part 22b in the embodiments described above. The first part 22a is provided between the protrusion 21c and the wall 11j1 (and the frame 13a). The second part 22c is provided between the protrusion 21c and the bottom surface 16a of the recess 16, and is connected to the first part 22a integrally. A structure including the buffering members 22E can also achieve the same results as those according to the embodiments and the modifications. Moreover, according to the third modification, when the buffering members 22E are provided by attaching the buffering members 22E to the respective protrusions 21c on the lid member 21, the first parts 22a are moved less from predetermined positions. When the recess 16 is covered by the lid member 21, the protrusions 21c are inserted into the recess 16. While being inserted into the recess 16, if the first part 22a provided to each of the protrusions 21c interferes with the sub-assembly 10 (the frame 13a), the first part 22a (the buffering member 22E) might get separated (peeled off, fall off) from the protrusion 21c. In the third embodiment, as an example, because each of the buffering members 22E comprises the second part 22c, even if the sub-assembly 10 interferers with the first part 22a, the first part 22a can be prevented from being pulled out from the second part 22c and being removed from the protrusion 21c.

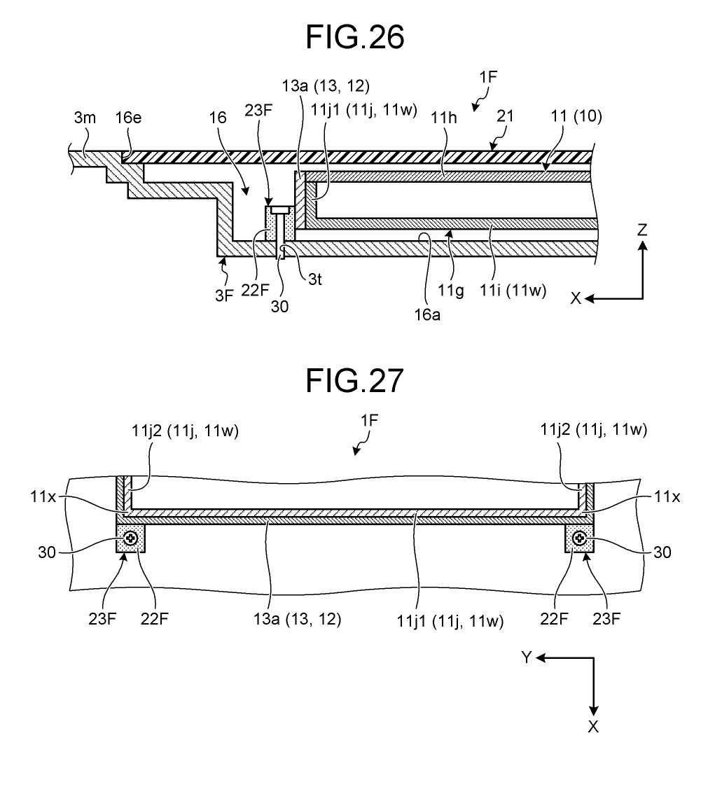

An electronic device 1F according to a fourth modification has a similar structure as those according to the embodiments and the modifications described above. Therefore, in the fourth modification as well, the same results as those achieved in the embodiments and the modifications can be achieved, as an example, because of the similar structure as those according to the embodiments and the first modifications. In the electronic device 1F according to the fourth embodiment, however, suppressors 23F and buffering members 22F (shock absorbers, buffering structures) illustrated in FIGS. 26 and 27 are provided, as an example, instead of the protrusions 21c, the suppressors 23C, the buffering members 22, and the like provided in the embodiments and the modifications described above. Using the couplers 30 (in the fourth modification, screws, as an example) that are coupled to respective coupling portions 3t (in the fourth modification, female screw holes, as an example) provided on a housing 3F of the electronic device 1F, the buffering members 22F are removably attached to the bottom surface 16a of the recess 16, in a manner protruding from the bottom surface 16a. Each of the buffering members 22F surrounds the coupler 30. A suppressor 23F comprises the coupler 30 and the buffering member 22F. In other words, in the fourth modification, the suppressors 23F are removably attached, in a manner protruding from the bottom surface 16a of the recess 16. According to the fourth modification, because the suppressors 23F and the buffering members 22F are removable, when the sub-assembly 10 (the module 11) is mounted on or removed from the housing 3F, the suppressors 23F and the buffering members 22F can be removed from the housing 3F, as an example. In this manner, interruption between the suppressors 23F, the buffering members 22F, and the sub-assembly 10 (the module 11) can be avoided. In the structure according to the fourth modification, the coupler 30 can be said to be an example of a suppressor.

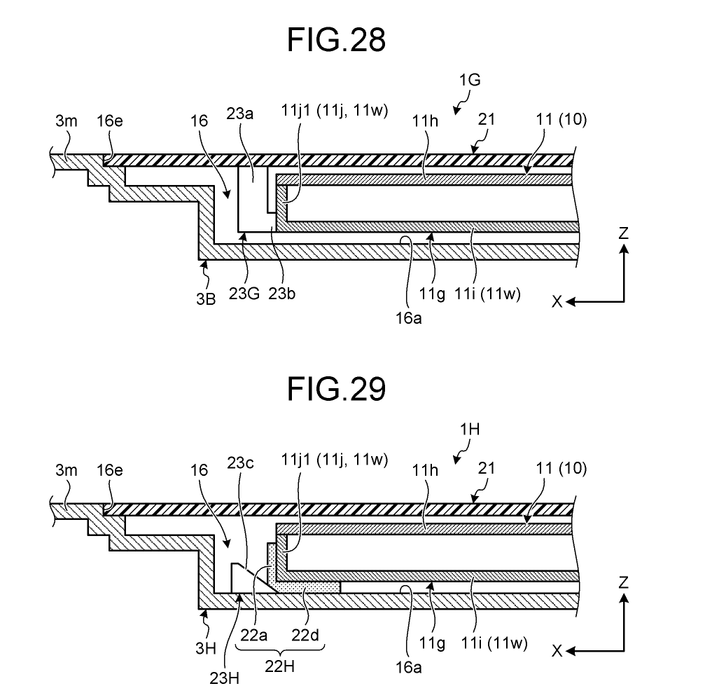

An electronic device 1G according to a fifth modification has a similar structure as those according to the embodiments and the modifications described above. Therefore, in the fifth modification as well, the same results as those achieved in the embodiments and the modifications can be achieved, as an example. In the electronic device 1G according to the fifth modification, however, suppressors 23G are provided, as illustrated in FIG. 28, instead of the protrusions 21c and the like provided in the embodiments and the modifications described above, as an example. The suppressors 23G protrude from the surface 21d of the lid member 21 into the recess 16, in the same manner as the protrusions 21c. In other words, the suppressors 23G are examples of a protrusion. Each of the suppressors 23G comprises a first part 23a protruding from the surface 21d, and a protrusion 23b protruding from the tip of the first part 23a toward the module 11. The protrusion 23b protrudes toward the first member 11g of the module 11, and is kept in contact with the first member 11g. Therefore, in the fifth modification, the distance between the suppressor 23G (a protrusion) and the first member 11g is shorter than the distance between the suppressor 23G (a protrusion) and the second member 11h. Therefore, according to the fifth modification, as an example, a larger force (load) acts on the first member 11g than that acting on the second member 11h, from the side of a housing 3B of the electronic device 1G. Therefore, as an example, in a structure where an abnormal condition occurs in the module 11 when a force (load) acts on the second member 11h, such abnormal conditions can be prevented from occurring.

An electronic device 1H according to a sixth modification has a similar structure as those according to the embodiments and the modifications described above. Therefore, according to the sixth modification as well, the same results as those achieved in the embodiments and the modifications can be achieved, as an example. In the electronic device 1H according to the sixth modification, however, suppressors 23H and buffering members 22H (shock absorbers, buffering structures) are provided, as illustrated in FIG. 29, as an example, instead of the protrusion 21c, the suppressors 23C, the buffering member 22, and the like provided in the embodiment or in the modifications described above. The suppressors 23H protrudes from the bottom surface 16a of the recess 16. Each of the suppressors 23H comprises a slanted surface 23c having a height getting smaller toward the connectors 15 and 18 (located on the right side in FIG. 29, not illustrated in FIG. 29). The slanted surface 23c can function as a guide (guiding surface) when the module 11 is mounted on a housing 3H of the electronic device 1H. Such a structure prevents the suppressors 23H from obstructing the module 11 being mounted on or removed from the housing 3H, as an example. In the sixth modification, each of the buffering members 22H comprises the first part 22a and a second part 22d. The first part 22a is provided between the suppressor 23H and the wall 11j1. The second part 22d is provided between the bottom surface 16a of the recess 16 and the wall 11i, and is connected to the first part 22a. In the sixth modification, the buffering members 22H are attached to the module 11, by making the buffering members 22H adhere to the module 11, for example.

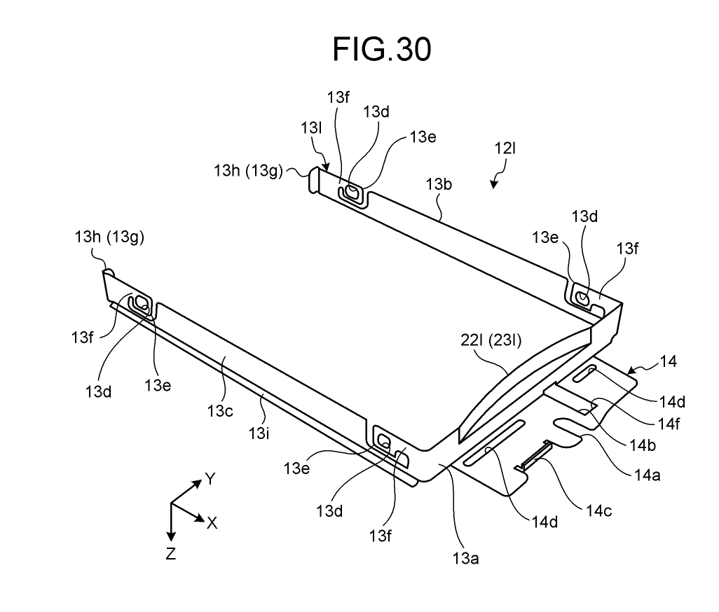

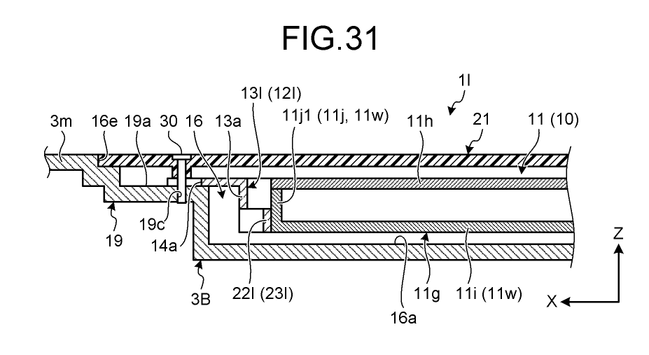

An electronic device 1I according to a seventh modification has a similar structure as those according to the embodiments and the modifications described above. Therefore, according to the seventh modification as well, as an example, the same results as those achieved in the embodiments and the modifications can be achieved. In the electronic device 1I according to the seventh modification, as an example, as illustrated in FIGS. 30 and 31, a holder 12I comprising a suppressor 23I (a shock absorber 22I (buffering structures)) is provided, instead of the protrusions 21c, the suppressors 23C, the buffering members 22, the holder 12, and the like provided in the embodiment or in the modifications described above. In the seventh modification, the suppressor 23I (the shock absorber 22I) is provided to the frame 13a of a surrounding portion 13I, on a side of the frame 13a that is away from the bracket 14, that is, a side facing the first member 11g when the holder 12I is assembled to the module 11. The suppressor 23I (the shock absorber 22I) is configured as a band-like section of the frame 13a extending at a constant width in the longitudinal direction. The longitudinal ends of the suppressor 23I (the shock absorber 22I) are connected to the longitudinal ends of the frame 13a. The longitudinal center of the band-like suppressor 23I (the shock absorber 22I) is removed from the frame 13a, and warped (projected) in a curve (arch) shape toward the connectors 15 and 18 (upper left in FIG. 30, right side in FIG. 31). In the seventh modification, as an example, the wall 11j1 of the first member 11g in the module 11 is kept in contact with the longitudinal center of the suppressor 23I (the shock absorber 22I), as illustrated in FIG. 31. When a force (load) acts between the module 11 and the holder 12, the suppressor 23I (the shock absorber 22I) can buffer the force (load) by being elastically or plastically deformed. The part projecting from the frame 13a has a function of the suppressor 23I, that is, a function of the shock absorber 22I. According to the seventh modification, as an example, the suppressor 23I (the shock absorber 22I) can be achieved in a relatively simple structure.

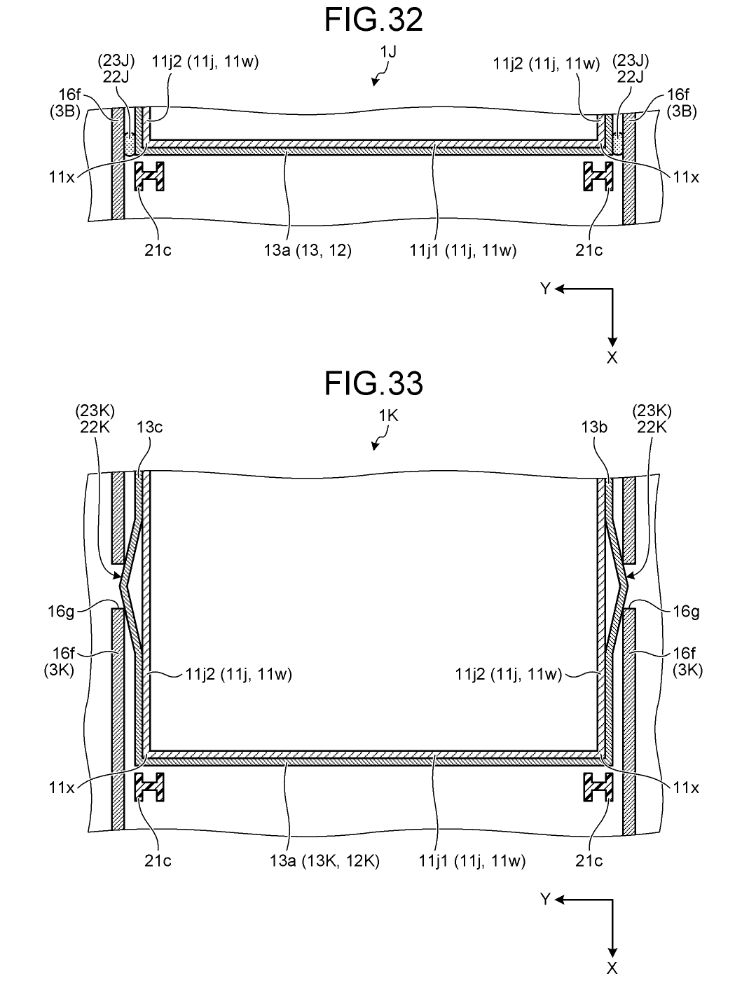

An electronic device 1J according to an eighth modification has a similar structure as those according to the embodiments and the modifications described above. Therefore, according to the eighth modification as well, as an example, the same results as those achieved in the embodiments and the modifications can be achieved. In the electronic device 1J according to the eighth modification, however, suppressors 23J (shock absorbers 22J (buffering structures)) are provided, as illustrated in FIG. 32, as an example, instead of the buffering member 22 and the like provided in the embodiment or in the modifications described above. In the eighth modification, the suppressor 23J (the shock absorber 22J) is provided between the wall 11j2 and a wall 16f of the housing 3B of the electronic device 1J. The suppressors 23J (the shock absorbers 22J) are made of elastic materials having elasticity and flexibility such as a synthetic resin material, a foamed material made of a synthetic resin, or an elastomer, for example. The suppressors 23J (the shock absorbers 22J) are provided between the wall 16f (a side wall) of the recess 16 provided in the housing 3B and the housing 11w (the holder 12) of the module 11. The suppressors 23J (the shock absorbers 22J) are sandwiched in a direction (in the eighth modification, as an example the direction perpendicular to, Y direction) intersecting with the direction in which the connector 15 and the connector 18 are coupled to each other (X direction) in an elastically compressed manner. Therefore, when a force (load) acts between the module 11 and the housing 3B, the suppressors 23J (the shock absorbers 22J) can buffer the force (load) by elastically being deformed. In the eighth modification, because the suppressors 23J (the shock absorbers 22J) are provided in an elastically compressed manner, the suppressors 23J (the shock absorbers 22J) are prevented from moving from predetermined positions, as an example. Furthermore, the buffering effects can be achieved from an initial stage while which the force (load) starts being applied, as an example. Furthermore, according to the eighth modification, the suppressors 23J (the shock absorbers 22J) can be achieved in a relatively simple structure, as an example.

An electronic device 1K according to a ninth modification has a similar structure as those according to the embodiments and the modifications described above. Therefore, according to the ninth modification as well, the same results as those achieved in the embodiments and the modifications can be achieved, as an example. In the electronic device 1K according to the ninth modification, as an example, suppressors 23K (shock absorbers 22K (buffering structures)) are provided, as illustrated in FIG. 33, instead of the buffering members 22 and the like provided in the embodiment or in the modifications described above. In the ninth modification, the suppressors 23K (the shock absorbers 22K) are provided to a frame 13b and a frame 13c comprising a surrounding portion 13K of a holder 12K. Each of the frames 13b and 13c is partially bent in a V-shape (or a U-shape) which forms each of the suppressors 23K (the shock absorbers 22K) protruding (projecting) toward an outer side of the module 11. Openings 16g (e.g., cutouts or through holes) for receiving at least a portion of the suppressors 23K (the shock absorbers 22K) are provided to the wall 16f of a housing 3K of the electronic device 1K, correspondingly to the suppressors 23K (the shock absorbers 22K). In the ninth modification, because the suppressors 23K (the shock absorbers 22K) are received inside of and held by the openings 16g, respectively, the module 11 is prevented from moving with respect to the housing 3K. When a force (load) acts between the module 11 and the housing 3K, the suppressors 23K (the shock absorbers 22K) can buffer the force (load), by being elastically or plastically deformed. When the module 11 is mounted on the housing 3K, the suppressors 23K (shock absorbers 22K) are elastically deformed and pushed away, so that the module 11 can be moved (slid) into the recess 16. Furthermore, according to the ninth modification, as an example, the suppressors 23K (shock absorbers 22K) can be achieved in a relatively simple structure.

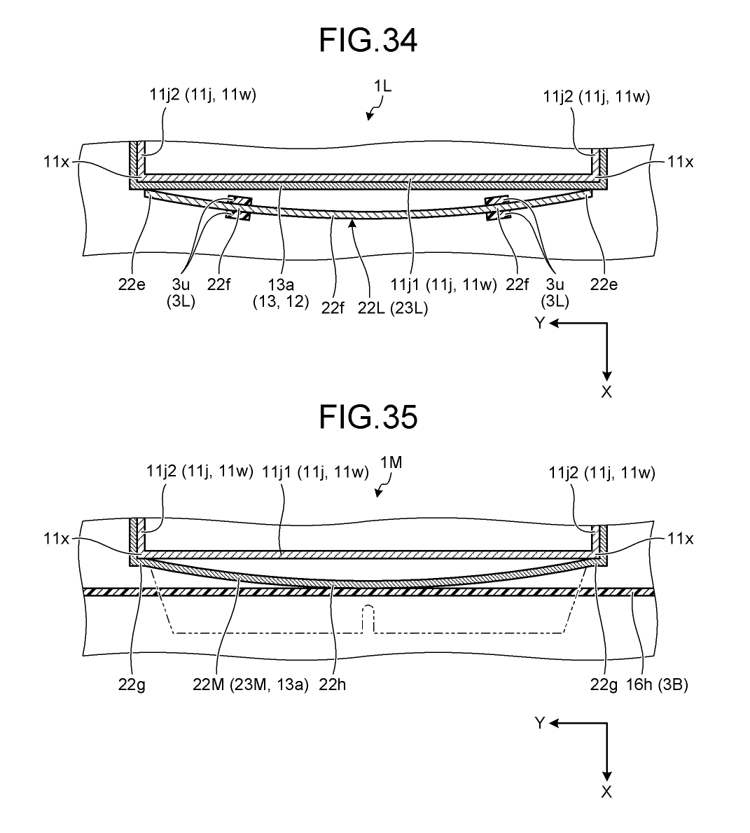

An electronic device 1L according to a tenth modification has a similar structure as those according to the embodiments and the modifications described above. Therefore, according to the tenth modification as well, as an example, the same results as those achieved in the embodiments and the modifications can be achieved. In the tenth electronic device 1L according to the tenth modification, however, a suppressor 23L (a shock absorber 22L (buffering structure)) are provided, as illustrated in FIG. 34, instead of the protrusions 21c, the buffering members 22, and the like provided in the embodiment or in the modifications described above, as an example. In the tenth modification, as an example, the suppressor 23L (the shock absorber 22L) is configured as a band-like plate member made of an elastic material (e.g., a metallic material). The suppressor 23L (the shock absorber 22L) is supported by being held between protrusions 3u (supports) provided to a housing 3L. The suppressor 23L (the shock absorber 22L) is bent, and longitudinal ends 22e of the suppressor 23L are kept closer to the wall 11j1 of the housing 11w of the module 11 than a longitudinal center 22f of the suppressor 23L. The ends 22e face corners 11x of the housing 11w of the module 11, and are kept in contact with the corners 11x, respectively. The ends 22e of the suppressor 23L (shock absorber 22L) are kept in contact with the first member 11g, but not in contact with the second member 11h. According to the tenth modification as well, when a force (load) acts between the module 11 and the housing 3L, the suppressor 23L (the shock absorber 22L) can buffer the force (load) by being elastically or plastically deformed. According to the tenth modification, as an example, the suppressor 23L (the shock absorber 22L) can be achieved in a relatively simple structure.

An electronic device 1M according to an eleventh modification has a similar structure as those according to the embodiments and the modifications described above. Therefore, according to the eleventh modification as well, as an example, the same results as those achieved in the embodiments and the modifications can be achieved. In the eleventh electronic device 1M according to the eleventh modification, however, a suppressor 23M (a shock absorber 22M (buffering structure)) are provided, as illustrated in FIG. 35, as an example, instead of the protrusions 21c, the buffering members 22, and the like provided in the embodiment or in the modifications described above. In the eleventh modification, as an example, the suppressor 23M (the shock absorber 22M) is provided as a portion of a surrounding portion 13M of a holder 12M. The suppressor 23M (the shock absorber 22M) is configured as at least a portion of the frame 13a. The suppressor 23M (the shock absorber 22M) is configured as a band-like section extending along the longitudinal direction of the wall 11j1 at a constant width. Longitudinal ends 22g of the suppressor 23M (shock absorber 22M) face the corners 11x of the housing 11w of the module 11, respectively. A longitudinal center 22h of the suppressor 23M (the shock absorber 22M) is removed from the wall 11j1, and warped (projected) in a curve (arch) toward a side opposite of the connectors 15 and 18 (to the bottom in FIG. 35). A wall 16h included in the housing 3B of the electronic device 1M is held in contact with the longitudinal center 22h of the suppressor 23M (shock absorber 22M). The wall 16h is positioned on the opposite side of the connector 18 in the recess 16. When a force (load) acts between the module 11 and the housing 3B, the suppressor 23M (the shock absorber 22M) can buffer the force (load) by being elastically or plastically deformed. The part projecting from the frame 13a functions as the suppressor 23M, and as the shock absorber 22M. According to the eleventh modification, as an example, the suppressor 23M (the shock absorber 22M) can be achieved in a relatively simple structure.

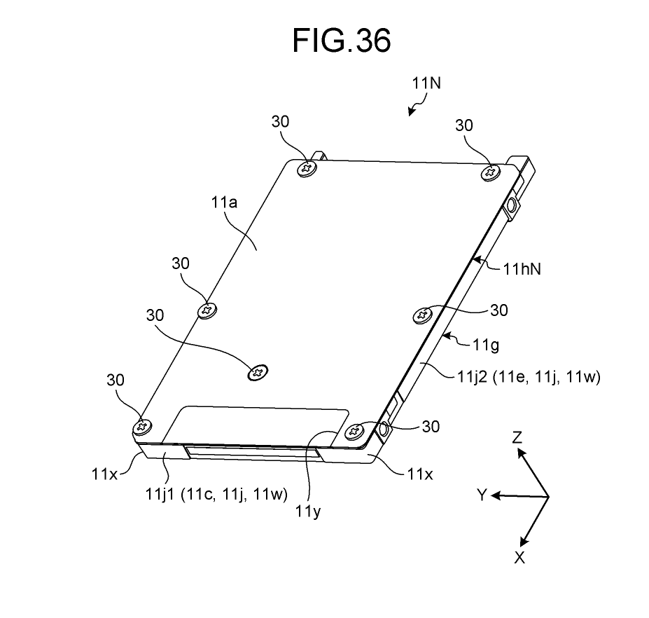

A module 11N according to a twelfth modification has a similar structure as those according to the embodiments and the modifications described above. Therefore, according to the twelfth modification as well, as an example, the same results as those achieved in the embodiments and the modifications can be achieved. In the module 11N according to the twelfth embodiment, a second member 11hN is provided, as illustrated in FIG. 36, as an example, instead of the second member 11h provided in the embodiment or in the modifications described above. In the twelfth modification, a rectangular, as an example, cutout 11y is provided to the second member 11hN, at the longitudinal center of the end located on the opposite side of the connector 15 (bottom in FIG. 36). A suppressor 23N (a shock absorber 22N (buffering structure)) is enclosed in the cutout 11y. In the twelfth modification, as an example, the board-like suppressor 23N (the shock absorber 22N) is held in the cutout 11y, in a manner filling the cutout 11y. The suppressor 23N (the shock absorber 22N) is a member that is softer, more elastic, and less stiff than the second member 11hN, as an example. Therefore, according to the twelfth modification, as an example, even if a force (load) acts on the module 11N, the force (load) is less communicated to the shaft 11p (see FIG. 6) located near the center of the second member 11hN. Therefore, as an example, the module 11N can be prevented from falling into an abnormal condition. The module 11N according to the twelfth modification may be used in the television receiver 1A or the electronic devices 1B to 1M according to the other embodiments or modifications.

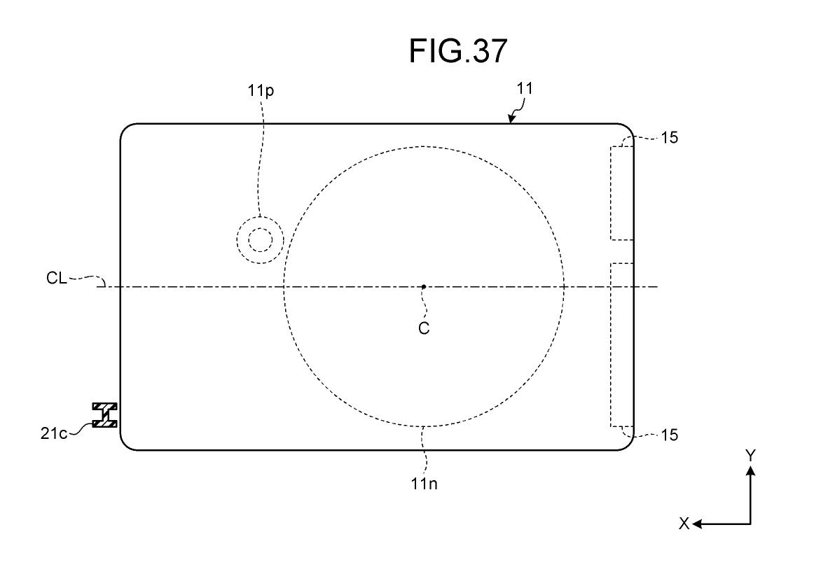

In a thirteenth modification, as illustrated in FIG. 37, a protrusion 21c (a suppressor) is positioned at the opposite side of the shaft 11p with respect to a center line CL of the module 11. The center line CL is a center line laid along the direction in which the connector 15 and the connector 18 (of which only the connector 15 is illustrated in FIG. 37) are coupled to each other (X direction). In the thirteenth modification, as viewed from the direction in which the connector 15 and the connector 18 are coupled to each other (X direction), the protrusion 21c and the shaft 11p are positioned offset from each other. Therefore, according to the thirteenth modification, when a force (load) acts on the module 11 in the direction in which the connector 15 and the connector 18 are coupled to each other (X direction), the force (load) acting on the shaft 11p will be smaller, compared with when the protrusion 21c and the shaft 11p are aligned, when viewed from the direction in which the connector 15 and the connector 18 are coupled to each other (X direction). Therefore, as an example, the module 11 can be prevented from falling into an abnormal condition. A central axis C of the disk 11n is on the center line CL.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. At an implementation stage, specifications (e.g., structure, type, direction, shape, size, length, width, thickness, height, number, arrangement, position, material) of each of the elements may be modified, as appropriate.

What is claimed is:

1. A television receiver comprising:
a display comprising a screen;
a first housing configured to at least partially house the display so that the screen is exposed, the first housing comprising a container and a first connector facing the container;
a second housing configured to be removably housed in the container, the second housing comprising a second connector electrically connected to the first connector;
a first member comprising an opening and a first portion of the second housing;
a second member configured to cover the opening, the second member comprising a second portion of the second housing;
a disk configured to be rotatably supported by the first member;
a shaft configured to be offset from the disk, and to extend between the first member and the second member;
an arm configured to support a head facing the disk, and to be rotatably supported by the shaft;
a lid member configured to cover the container and to be removably provided to the first housing;
a protrusion configured to be provided to the lid member, to be opposite the first connector with respect to the second connector, to protrude into the container, and to prevent the first connector and the second connector from being separated from each other and electrically disconnected; and
a shock absorber configured to be provided to at least one of the first housing, the second housing, and the lid member, and to prevent a force applied from the lid member from acting on the second member via the protrusion.

2. The television receiver of claim 1, wherein
the second housing comprises:
a first wall facing the protrusion; and
a second wall connected to an end of the first wall in a longitudinal direction of the first wall and extended in a direction in which the first connector and the second connector are coupled to each other, and
the protrusion is configured to face the end of the first wall.

3. The television receiver of claim 1, wherein a distance between the protrusion and the first member is configured to be shorter than a distance between the protrusion and the second member.

4. The television receiver of claim 1, wherein the protrusion and the shaft are configured to be offset from each other when viewed from a direction in which the first connector and the second connector are coupled to each other.

5. The television receiver of claim 1, wherein the shock absorber comprises:
a first part between the protrusion and a first wall of the second housing facing the protrusion; and
a second part between the lid member and a third wall of the second housing intersecting with the first wall and facing the lid member.

6. The television receiver of claim 1, further comprising a third member configured to be provided to the second housing and to be between the protrusion and the second housing, wherein
the shock absorber is provided to the third member.

7. The television receiver of claim 1, wherein the shock absorber is configured to be sandwiched between the first housing or the lid member and the second housing in a direction intersecting a direction in which the first connector and the second connector are coupled to each other, so that the shock absorber is provided in an elastically compressed manner.

8. The television receiver of claim 1, wherein the shock absorber is provided removably.

9. An electronic device comprising:
a first housing comprising a container and a first connector facing the container;
a second housing configured to be removably housed in the container, the second housing comprising a second connector electrically connected to the first connector;
a suppressor configured to be provided to at least one of the first housing and the second housing, and to prevent the first connector and the second connector from moving in a direction in which the first connector and the second connector are separated from each other; and
a buffering structure configured to prevent a force applied from the suppressor from acting on the second housing.

10. An electronic device comprising:
a first housing comprising a container and a first connector facing the container;
a second housing configured to be removably housed in the container, the second housing comprising a second connector electrically connected to the first connector; and
a suppressor configured to be provided to an end of at least one of the first housing and the second housing in a direction along a longitudinal direction of the first connector and the second connector, and to prevent the first connector and the second connector from moving in a direction to separate from each other.
